(19) United States
(12) Patent Application Publication
(10) Pub. No.: US 2026/0015743 A1
(43) Pub. Date: Jan. 15, 2026

(54) MEDIATED HYDROGEN ANODE FOR USE IN REDUCTIVE ELECTROSYNTHESIS

(71) Applicant: Wisconsin Alumni Research Foundation, Madison, WI (US)

(72) Inventors: Shannon Stahl, Madison, WI (US); James Gerken, Madison, WI (US); Jack Twilton, Madison, WI (US); Mathew Johnson, Madison, WI (US); Thatcher Root, Madison, WI (US)

(21) Appl. No.: 17/853,441

(22) Filed: Jun. 29, 2022

Related U.S. Application Data
(60) Provisional application No. 63/216,051, filed on Jun. 29, 2021.

(51) Int. Cl. C25B 11/042; C25B 1/02; H01M 8/0656

(52) U.S. Cl. CPC C25B 11/042; C25B 1/02; H01M 8/0656

(57) ABSTRACT

An electrosynthetic cell and its use are disclosed. The electrosynthetic cell can be used in a reductive electrosynthesis of one or more desired chemical products from one or more chemical reactants. The electrosynthetic cell comprises a hydrogen anode half-cell and a cathode half-cell. The hydrogen anode half-cell comprises hydrogen (H₂), a first liquid phase solution that is in contact with an anode and a heterogeneous redox catalyst capable of catalyzing the oxidation of H₂ to H⁺, and a redox mediator capable of transferring or accepting electrons and/or protons while undergoing reduction or oxidation. The cathode half-cell comprises a second liquid phase solution comprising the one or more chemical reactants that is in contact with a cathode and a reductive synthesis catalyst capable of catalyzing the reductive synthesis of the one or more desired chemical products from the one or more chemical reactants.

### CROSS-REFERENCE TO RELATED APPLICATIONS

This application claims the benefit of priority of U.S. Provisional Patent Application Ser. No. 63/216,051, filed Jun. 29, 2021, the contents of which is incorporated by reference in its entirety.

### STATEMENT REGARDING FEDERALLY SPONSORED RESEARCH/DEVELOPMENT

This invention was made with government support under DE-AC05-76RL01830 awarded by the US Department of Energy. The government has certain rights in the invention.

### FIELD OF THE INVENTION

The present disclosure relates to an electrosynthetic cell comprising a flow-based hydrogen anode half-cell and methods of use thereof. The electrosynthetic cell can be used in a reductive electrosynthesis of one or more desired chemical products from one or more chemical reactants.

### BACKGROUND OF THE INVENTION

Current methods for reductive electrosynthesis often utilize as reductants sacrificial metal anodes that have limited lifetime and generate significant metal ion waste streams, or they use another sacrificial chemical process, such as water oxidation. While effective, such systems generate problematic waste and are inefficient, due to the thermodynamic potential required to drive reactions such as water oxidation. As a result, there is a need in the art for systems that operate at lower potentials and that eliminate the use of sacrificial reductant materials.

Hydrogen gas (H₂) is widely used as a reductant in anodes used in fuel cells and other energy conversion devices. In U.S. Pat. No. 10,727,518 and U.S. Patent Publication No. 2018/0358642, which are incorporated by reference herein, Stahl et al. disclose a flow-based hydrogen anode half-cell for use in fuel cells utilizing a heterogeneous redox catalyst that is not affixed to the anode and a redox mediator for transferring electrons and/or protons between the heterogeneous redox catalyst and the anode. In operation, the H₂ reductant is oxidized to H⁺ at the heterogeneous redox catalyst, while the redox mediator is simultaneously reduced from its oxidized form to its reduced form. The reduced form of the redox mediator then migrates to the anode, where it is oxidized back to its oxidized form. The oxidized form of the redox mediator then migrates back to the heterogeneous redox catalyst, where the process can be repeated through many cycles, as H₂ is continuously oxidized to H⁺.

While H₂ anode half-cells are widely used in fuel cells, the hydrogen reductant does not have sufficient electrochemical potential (i.e., thermodynamic driving force) to promote many catalyzed reduction reactions under thermal conditions. Nor has this technology been successfully adapted for use in electrosynthetic cells, or more specifically for pairing with reductive organic electrosynthesis occurring within a cathode half-cell containing organic solvent.

Accordingly, there remains a need in the art for new uses for hydrogen-based anode half-cells in reductive electrosynthesis applications, in order to (1) avoid the wasteful use of sacrificial metal anodes or other sacrificial chemical reductants, and/or (2) provide a means to “supercharge” hydrogen to make it a stronger reductant.

### BRIEF SUMMARY

In this disclosure, we address the known limitations of flow-based hydrogen anode half-cells by “supercharging” the electrons from H₂ with an externally-applied electromotive force (EMF), enhancing its reduction potential to a level suitable to drive a catalyzed reductive synthesis reaction occurring within a paired cathode half-cell. This new combination of previously disclosed flow-based hydrogen anode half-cell technology with electrolysis/reductive electrosynthesis technology results in synergistically improved synthetic methods that produce reduced waste streams having lower toxicity, as compared to previously disclosed methods of reductive electrosynthesis.

In a first aspect, this disclosure encompasses an electrosynthetic cell for use in the reductive electrosynthesis of one or more desired chemical products. The electrosynthetic cell includes (1) a hydrogen anode half-cell comprising (i) hydrogen (H₂), (ii) a first liquid phase solution that is in contact with an anode and a heterogeneous redox catalyst capable of catalyzing the oxidation of H₂ to H⁺, wherein the heterogeneous redox catalyst is not affixed to the anode; and (iii) a redox mediator, wherein the redox mediator is capable of transferring or accepting electrons and/or protons while undergoing reduction or oxidation and (2) a cathode half-cell comprising a second liquid phase solution comprising the one or more chemical reactants that is in contact with a cathode and a reductive synthesis catalyst capable of catalyzing the reductive synthesis of the one or more desired chemical products from the one or more chemical reactants.

In some embodiments, the one or more chemical reactants comprise a first chemical reactant selected from an aryl halide, a heteroaryl halide, an alkenyl halide, or any combination thereof and a second chemical reactant selected from an alkyl halide, a cycloalkyl halide, a heterocycloalkyl halide, or any combination thereof.

In some embodiments, the molar ratio of the first chemical reactant to the second chemical reactant is from 1:1 to 1:2. In some embodiments, the molar ratio of the first chemical reactant to the second chemical reactant is from 1:1 to 1:1.8, from 1:1 to 1:1.6, from 1:1 to 1:1.5, from 1:1 to 1:1.3, or from 1:1 to 1:1.1.

In some embodiments, the alkyl halide, the cycloalkyl halide, or the heterocycloalkyl halide is optionally substituted with one or more substituents selected from the group consisting of alkyl, haloalkyl, halo, CN, cycloalkyl optionally substituted with one or more halo, —O-cycloalkyl, heterocycloalkyl, —O-heterocycloalkyl, aryl, —O-aryl, heteroaryl, —O-heteroaryl, alkoxy, haloalkoxy, hydroxy, —C(O)OR¹, —OC(O)R¹, —C(O)R₁, —NR₁R², —C(O)NR₁R², and —NR₁C(O)R², and R¹ and R² are independently selected from the group consisting of hydrogen, alkyl, —C(O)—O— alkyl, cycloalkyl, heterocycloalkyl, aryl and heteroaryl.

In some embodiments, the aryl halide, the heteroaryl halide, or the alkenyl halide is optionally substituted with one or more substituents selected from the group consisting of alkyl, haloalkyl, halo, CN, —B(O₂C₂(CH₃)₄), cycloalkyl, —O-cycloalkyl, heterocycloalkyl, —O— heterocycloalkyl, aryl, —O-aryl, heteroaryl, —O-heteroaryl optionally substituted with NR³R⁴, alkoxy, haloalkoxy, hydroxy, —C(O)OR³, —OC(O)R³, —C(O)R₁, —NR³R⁴, —C(O)NR³R⁴, and —NR³C(O)R⁴, and R³ and R⁴ are independently selected from the group consisting of hydrogen, alkyl, —C(O)—O-alkyl, cycloalkyl, heterocycloalkyl, aryl and heteroaryl.

In some embodiments, the redox mediator is dissolved within the liquid phase solution and is capable of moving between the anode and the heterogeneous redox catalyst. The electrosynthetic cell is configured to reduce an oxidized form of the redox mediator at the redox catalyst and oxidize a reduced form of the redox mediator at the anode.

In some embodiments, the H₂ is in contact with the heterogeneous redox catalyst. In some such embodiments, the H₂ is in the form of a gas.

In some embodiments, the H₂ is being oxidized at the heterogeneous redox catalyst.

In some embodiments, the redox mediator includes one or more carbon atoms. In some such embodiments, the reduced form of the redox mediator is a substituted dihydroxybenzene, a substituted hydrazine, a substituted hydroxylamine, or a substituted heterocycle. In some such embodiments, the substituted heterocycle is a dihydropyridine, a dihydroflavin, or a dihydroindigo. In other such embodiments, the substituted dihydroxybenzene is a 1,2-dihydroxybenzene or a 1,4-dihydroxybenzene.

In some embodiments, the substituted dihydroxybenzene has one or more hydrogen atoms on the dihydroxybenzene ring substituted with a substituent group that is independently an alkyl with less than ten carbons, an aryl, a fused aryl, a heterocycle, an alkenyl, an alkynyl, a cycloalkyl, an amine, a protonated amine, a quaternary ammonium, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, or combinations of two or more of the foregoing. In some such embodiments, the fused aryl is naphthohydroquinone, anthrahydroquinone, or a derivative thereof.

In some embodiments, the substituted hydrazine has one or more hydrazine hydrogen atoms substituted with a substituent group that is independently an alkyl with less than ten carbons, an aryl, a heterocycle, an alkenyl, an alkynyl, a cycloalkyl, an amine, a protonated amine, a quaternary ammonium, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, or combinations of two or more of the foregoing.

In some embodiments, the substituted hydroxylamine has one or more nitrogen-bound hydrogen atoms substituted with a substituent group that is independently an alkyl with less than ten carbons, an aryl, a cycloalkyl, or a bicycloalkyl. In some such embodiments, both nitrogen-bound hydroxylamine hydrogen atoms are substituted with (a) the same substituents, (b) different substituents, or (c) substituents that are linked together to form a heterocycle.

In some embodiments, one or more of the substituent groups further includes an alkyl with less than ten carbons, an aryl, a heterocycle, an alkenyl, an alkynyl, a cycloalkyl, an amine, a protonated amine, a quaternary ammonium, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, or combinations of two or more thereof on the same or on different positions on the substituent.

In some embodiments, the substituted heterocycle has one or more heterocycle hydrogen atoms substituted with a substituent group that is an alkyl with less than ten carbons, an aryl, a heterocycle, an alkenyl, an alkynyl, a cycloalkyl, an amine, a protonated amine, a quaternary ammonium, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, or combinations of two or more thereof on the same or on different positions on the substituent.

In some embodiments, the reduced form of the redox mediator is selected from the group consisting of 1,4-dihydroxybenzene, 9,10-dihydroxyanthracene, and combinations thereof. In some embodiments, the 1,4-dihydroxybenzene or 9,10-dihydroxyanthracene is optionally substituted with one or more substituents selected from the group consisting of alkyl and thioether substituted with sulfonate.

In some embodiments, the redox mediator is from 0.1 mol % to 40 mol %, based on the molar amount of the first chemical reactant. In some embodiments, the redox mediator is from 0.5 mol % to 35 mol %, from 0.8 mol % to 32 mol %, from 1 mol % to 30 mol %, from 2 mol % to 28 mol %, from 3 mol % to 25 mol %, from 4 mol % to 20 mol %, or from 5 mol % to 20 mol %, based on the molar amount of the first chemical reactant.

In some embodiments, the redox mediator is at least 0.1 mol %, based on the molar amount of the first chemical reactant. In some embodiments, the redox mediator is at least 0.2 mol %, at least 0.3 mol %, at least 0.4 mol %, at least 0.5 mol %, at least 0.6 mol %, at least 0.7 mol %, at least 0.8 mol %, at least 0.9 mol %, at least 1.0 mol %, at least 2.0 mol %, at least 3.0 mol %, at least 4.0 mol %, or at least 5.0 mol % based on the molar amount of the first chemical reactant. In some embodiments, the redox mediator less than 40.0 mol %, 30.0 mol %, 20.0 mol %, or 10.0 mol % based on the molar amount of the first chemical reactant.

In some embodiments, the redox mediator has a concentration of at least 5 mM in the first liquid phase solution. In some embodiments, the redox mediator has a concentration of at least 6 mM, at least 7 mM, at least 8 mM, at least 9 mM, or at least 10 mM in the first liquid phase solution. In some embodiments, the redox mediate has a concentration less than 100 mM, 90 mM, 80 mM, 70 mM, 60 mM, 50 mM, 40 mM, 30 mM, or 20 mM.

In some embodiments, the heterogeneous redox catalyst includes one or more metals selected from Pt, Pd, Ru, Co, Mn, Fe, Cu, V, Mo, Rh, Ag, Au, W, Os, Ni, Cr, or Ir. In some such embodiments, the redox catalyst comprises one or more metals selected from the group consisting of Pt, Pd, and combinations thereof.

In some embodiments, the redox catalyst is from 0.01 mol % to 15 mol %, based on the molar amount of the first chemical reactant. In some embodiments, the redox catalyst is from 0.05 mol % to 13 mol %, from 0.1 mol % to 11 mol %, from 0.15 mol % to 9 mol %, from 0.2 mol % to 7 mol %, from 0.25 mol % to 6 mol %, or from 0.3 mol % to 5 mol %, based on the molar amount of the first chemical reactant.

In some embodiments, the redox catalyst is at least 1 mol %, based on the molar amount of the redox mediator. In some embodiments, the redox catalyst is at least 5 mol %, at least 10 mol %, at least 15 mol %, at least 20 mol %, at least 25 mol %, at least 30 mol %, at least 35 mol %, at least 40 mol %, at least 45 mol %, or at least 50 mol % based on the molar amount of the redox mediator. In some embodiments, the redox catalyst is less than 100 mol %, 90 mol %, 80 mol %, 70 mol %, or 60 mol % based on the molar amount of the redox mediator.

In some embodiments, the heterogeneous redox catalyst is deposited, adsorbed, covalently linked, or otherwise attached to a support. In some such embodiments, the support is a carbon-based material, silica, a metal oxide, a metal chalcogenide, an oxynitride, a nitride, a boride, or a carbide.

In some embodiments, the heterogeneous redox catalyst includes a heterogenized molecular catalyst.

In some embodiments, the electrosynthetic cell further includes an anode flow reactor containing the heterogeneous redox catalyst, where the anode flow reactor is configured to facilitate contact of the heterogeneous redox catalyst with a flowing fluid or a mixture of flowing fluids including the first liquid phase solution, the redox mediator, and the H₂. In some such embodiments, the anode flow reactor includes the flowing fluid or mixture of flowing fluids that includes the first liquid phase solution, the redox mediator, and the H₂.

In some embodiments, the electrosynthetic cell further comprises a device capable of applying an external electromotive force to the anode and the cathode to remove electrons from the anode and to add electrons to the cathode.

In some embodiments, the external electromotive force has a current density of from 0.01 mA·cm⁻² to 20 mA·cm⁻². In some embodiments, the external electromotive force has a current density of from 0.1 mA·cm⁻² to 18 mA·cm⁻², from 0.2 mA·cm⁻² to 16 mA·cm⁻², from 0.3 mA·cm⁻² to 14 mA·cm⁻², from 0.4 mA·cm⁻² to 12 mA·cm⁻², from 0.8 mA·cm⁻² to 10 mA·cm⁻², from 1 mA·cm⁻² to 8 mA·cm⁻², from 1.5 mA·cm⁻² to 6 mA·cm⁻², or from 2 mA·cm⁻² to 4 mA·cm⁻².

In some embodiments, the anode includes carbon. In some such embodiments, the carbon is in the form of carbon paper, carbon cloth or carbon felt.

In some embodiments, the first liquid phase solution of the anode half-cell or the second liquid phase solution of the cathode half-cell includes one or more organic solvents. In some such embodiments, the first liquid phase solution of the anode half-cell or the second liquid phase solution of the cathode half-cell is selected from the group consisting of N-methylpyrrolidone (NMP), N,N-dimethylformamide (DMF), N,N-dimethylacetamide (DMA), N,N′-dimethylpropyleneurea (DMPU), propylene carbonate, tetrahydrofuran (THF), methanol (MeOH), acetonitrile (MeCN), 1,3-dimethyl-2-imidazolidinone (DMI), and combinations thereof.

In some embodiments, the first liquid phase solution of the anode half-cell or the second liquid phase solution of the cathode half-cell further comprises a supporting electrolyte selected from the group consisting of tetrabutylammonium hexafluorophosphate (NBu₄PF₆), lithium bromide (LiBr), potassium hexafluorophosphate (KPF₆), cesium fluoride (CsF), lithium chloride (LiCl), tetrabutylammonium tetrafluoroborate (NBu₄BF₄), potassium chloride (KCl), and combinations thereof.

In some embodiments, the cathode includes the reductive synthesis catalyst. In some such embodiments, the reductive synthesis catalyst is affixed to the cathode.

In some embodiments, the reductive synthesis catalyst is not affixed to the cathode.

In some embodiments, the cathode half-cell further includes a redox mediator including at least one carbon atom, where the redox mediator is capable of transferring or accepting electrons and/or protons while undergoing reduction or oxidation.

In some embodiments, the reductive synthesis catalyst includes carbon or one or more metals selected from Pt, Pd, Ru, Co, Mn, Fe, Cu, V, Mo, Rh, Ag, Au, W, Os, Ni, Cr, or Ir. The reductive synthesis catalyst may comprise a ligand. The ligand may be selected to increase catalytic activity or improve another property of the catalyst. In some embodiments, the ligand may be selected to improve solubility of the reductive synthesis catalyst and the ligand may be substituted or eschewed in a different solvent system.

In some embodiments, the reductive synthesis catalyst comprises Ni and one or more ligands selected from the group consisting of 4,4′-di-tert-butyl-2,2-dipyridyl (dtbbpy), 4,4,′,4″-tri-tert-butyl-2,2′:6′,2″-terpyridine (ttbtpy), 2,9-dimethylphenanthroline, bathocuperoine, 1,2-bis(diphenylphosphino)ethane, and combinations thereof.

In some embodiments, the reductive synthesis catalyst is from 0.1 mol % to 30 mol %, based on the molar amount of the first chemical reactant. In some embodiments, the reductive synthesis catalyst is from 0.5 mol % to 28 mol %, from 1 mol % to 25 mol %, from 1.5 mol % to 23 mol %, from 2 mol % to 20 mol %, from 2.5 mol % to 18 mol %, from 3 mol % to 16 mol %, from 3.5 mol % to 15 mol %, from 4 mol % to 13 mol %, or from 5 mol % to 10 mol %, based on the molar amount of the first chemical reactant.

In some embodiments, the one or more ligands comprise dtbbpy and ttbtpy, and the ratio of dtbbpy to ttbtpy is from 1:2 to 5:1. In some embodiments, the ratio of dtbbpy to ttbtpy is from 1:1 to 4:1.

In some embodiments, the hydrogen anode half-cell further comprises a base capable of accepting a H⁺ and liberating an alkali. In some embodiments, the base is selected from the group consisting of alkali carbonate, alkali hydroxide, alkali phosphate, alkali zeolite, strong base anion (SBA) exchange resin, and combinations thereof. In some embodiments, the alkali carbonate is sodium carbonate, lithium carbonate, cesium carbonate, potassium carbonate, or combinations thereof. In some embodiments, the alkali hydroxide is sodium hydroxide, lithium hydroxide, cesium hydroxide, potassium hydroxide, or combinations thereof. In some embodiments, the alkali phosphate is sodium phosphate, lithium phosphate, cesium phosphate, potassium phosphate, or combinations thereof. In some embodiments, the alkali zeolite is sodium zeolite, lithium zeolite, cesium zeolite, potassium zeolite, or combinations thereof. In some embodiments, the strong base anion (SBA) exchange resin is sold commercially as Amberlite® Type I (trialkylbenzyl ammonium), Dowex© Type I (trimethylbenzyl ammonium), Amberlite® Type II (dimethyl-2-hydroxyethylbenzyl ammonium), or Dowex© Type II (dimethyl-2-hydroxyethylbenzyl ammonium), etc.

In some embodiments, a molar ratio of the base to the first chemical reactant is from 1:1 to 1:4. In some embodiments, a molar ratio of the base to the first chemical reactant is from 1:1.2 to 1:2.8, from 1:1.4 to 1:2.6, from 1:1.5 to 1:2.5, from 1:1.5 to 1:3, or from 1:1.5 to 1:3.5.

In some embodiments, the cathode half-cell further comprises one or more desired chemical products and the one or more desired chemical products comprise a reductive C(sp²)-C(sp³) coupled product.

In some embodiments, the hydrogen anode half-cell is in ionic communication with the cathode half-cell.

In some embodiments, the cathode includes nickel foam or carbon cloth.

In some embodiments, the one or more chemical reactants are in contact with the cathode, the reductive synthesis catalyst, or both.

In some embodiments, the one or more desired chemical products are produced within the cathode half-cell from the one or more chemical reactants.

In some embodiments, the electrosynthetic cell further includes an anion exchange membrane separating the hydrogen anode half-cell and the cathode half-cell. In some such embodiments, the anion exchange membrane is impermeable to H⁺ ions.

In some embodiments, the electrosynthetic cell further includes a cation exchange membrane separating the hydrogen anode half-cell and the cathode half-cell.

In some embodiments, the reductive synthesis catalyst is capable of catalyzing reductive cross-coupling, reductive homo-coupling, Birch reduction, phosphine oxide reduction, reductive dimerization, reductive amination, reductive hindered amine synthesis, reductive amidation, reductive decyanation, reductive dehalogenation, reductive etherification, reductive alcohol synthesis, reductive Heck reaction, reductive cyclization, reductive alkylation, reduction of nitroarenes, and reductive carboxylation.

In a second aspect, this disclosure encompasses a method of using the electrosynthetic cell described herein to produce one or more desired chemical products from one or more chemical reactants. The method includes applying an external electromotive force to remove electrons from the anode and to add electrons to the cathode. In some embodiments, the external electromotive force has a current density of from 0.01 mA·cm⁻² to 20 mA·cm⁻² 0.1 mA·cm⁻² to 18 mA·cm⁻², from 0.2 mA·cm⁻² to 16 mA·cm⁻², from 0.3 mA·cm⁻² to 14 mA·cm⁻², from 0.4 mA·cm⁻² to 12 mA·cm⁻², from 0.8 mA·cm⁻² to 10 mA·cm⁻², from 1 mA·cm⁻² to 8 mA·cm⁻², from 1.5 mA·cm⁻² to 6 mA·cm⁻², or from 2 mA·cm⁻² to 4 mA·cm⁻².

In some embodiments, applying an external electromotive force to remove electrons from the anode and to add electrons to the cathode results in oxidation of H₂ to H⁺ at the redox catalyst, reversable reduction and oxidation of the redox mediator, and reduction of the one or more chemical reactants to produce the one or more desired chemical products. In some such embodiments, the external electromotive force has a current density of from 0.01 mA·cm⁻² to 20 mA·cm⁻².

The above and still other advantages of the present disclosure will be apparent from the description that follows. However, the following description is merely of specific non-limiting exemplary embodiments. The full scope of the invention is described in the appended claims.

### BRIEF DESCRIPTION OF THE DRAWINGS

FIG. 1 depicts a general scheme for an exemplary electrosynthetic cell including a flow-based hydrogen anode half-cell using H₂ as the terminal reductant, and a cathode half-cell where the desired chemical product is made from two reactants by reductive synthesis (e.g., by Ni-catalyzed cross-electrophile coupling).

FIG. 2 depicts structures and cyclic voltammograms of potential hydrogen anode mediators. The dotted line indicates the approximate redox potential of hydrogen in DMF. CVs where conducted with a glassy carbon working electrode, platinum wire counter electrode and internally references to a Ag/Ag⁺ calibrated to Fc/Fc⁺.

FIG. 3 shows reduction of AQS on carbon-supported Pt and Pd catalysts at 24° C. and 70° C. Full substrate conversion would occur at −100 μmol of consumed H₂.

FIGS. 4A and 4B show reduction of other potential mediators on supported Pd catalysts at 24° C. in DMF or MeCN. Full substrate conversion would occur at −100 mmol of consumed H₂. FIG. 4A demonstrates reduction of Na(Fe·EDTA). FIG. 4B depicts reduction of TMT HQ.

FIG. 5 depicts the anodic system used hydrogen as a terminal reductant and AQS as a proton- and electron-mediator, and neutralized generated protons with exogenous heterogeneous base (Li₂CO₃). The cathodic system leveraged the facile single-electron reduction of Bobbitt's salt, which acted as the terminal oxidant.

FIG. 6A shows schematic of Electrosyn micro cell used for mediated H₂ bench marking.

FIG. 6B shows schematic for anode flow path.

FIG. 7 shows current benchmarking experiments for electrochemical Na-AQS mediated H₂ oxidation with Bobbitt's salt as terminal oxidant.

FIG. 8 demonstrates Ni-catalyzed cross electrophile coupling of ethyl 4-bromobenzoate and 1-bromo-3-phenylpropane used for reaction optimization.

FIG. 9 shows optimization of Ni-catalyzed cross electrophile coupling.

FIG. 10 shows optimization of Ni-catalyzed cross electrophile coupling with electron deficient 2-chloropyridines.

FIG. 11 depicts optimization of Ni-catalyzed cross electrophile coupling with a bis-amino pyrimidine substrate for the synthesis of Gefipixant.

FIG. 12 shows Ni-catalyzed cross electrophile coupling on 1 mmol scale.

FIG. 13 shows Ni-catalyzed cross electrophile coupling on gram scale.

FIG. 14 demonstrates time course data for the Ni-catalyzed cross electrophile coupling of 1-bromo-3-phenylpropane and ethyl-4-bromobenzoate under optimized conditions. 5 mA·cm^{-2 0.5} M in ArBr substrate.

FIG. 15A is schematic of Electrosyn micro cell used for mediated H₂ anode synthesis on gram scale. FIG. 15B demonstrates schematic for parallel flow set-up.

FIG. 16 shows Ni-catalyzed cross electrophile coupling used to evaluation effect of current density on selectivity.

FIG. 17 depicts Ni-catalyzed cross electrophile coupling on 100 gram scale.

FIG. 18 demonstrates LCAP data of product and Ar—Cl SM from the 100 g scale synthesis as a function of supplied charge. LCAP was determined by integrating all SM related peaks and dividing the area of the product by that combined area.

### DETAILED DESCRIPTION

The disclosed devices and methods are not limited to the particular methodology, protocols, materials, and reagents described, as these may vary. Furthermore, the terminology used herein is for the purpose of describing particular embodiments only, and is not intended to limit the scope of the present invention, which is limited only by the pending claims.

As used herein and in the appended claims, the singular forms “a”, “an”, and “the” include plural reference, unless the context clearly dictates otherwise. Accordingly, the terms “a” (or “an”), “one or more” and “at least one” can be used interchangeably. The terms “comprising,” “including,” and “having” can also be used interchangeably.

Unless defined otherwise, all technical and scientific terms used herein have the same meanings as commonly understood by one of ordinary skill in the art. Although any methods and materials similar or equivalent to those described herein can be used in the practice or testing of the present invention, the methods and materials of exemplary non-limiting embodiments are now described. All publications and patents specifically mentioned herein are incorporated by reference in their entirety for all purposes.

This disclosure is based on the inventors' systems and methods for reductive electrochemical synthesis. The disclosed systems and methods use an electrosynthetic cell comprising a flow-based hydrogen anode half-cell that used H₂ as the terminal reductant and a cathode half-cell. The electrosynthetic cell can be used for the reductive electrosynthesis of one or more desired chemical products from one or more chemical reactants present within the cathode half-cell. When an external electromotive force is applied to the electrosynthetic cell (pushing electrons into the cathode half-cell and withdrawing electrons from the hydrogen anode half-cell), the H₂ within the hydrogen anode half-cell is oxidized to H⁺ ion, while the one or more chemical reactants within the cathode half-cell are simultaneously reduced to form the one or more desired chemical products.

Within the hydrogen anode half-cell, a heterogeneous redox catalyst that is not affixed to the anode can be paired with a redox mediator to facilitate the electrocatalytic oxidation of H₂ within an anode half-cell. Accordingly, the disclosure encompasses an electrosynthetic cell comprising an anode half-cell that includes an anode electrode and a redox catalyst that is not affixed to the anode, along with an electrolyte solution (anolyte) in contact with the electrode and the heterogeneous redox catalyst. The anolyte contains a carbon-containing redox mediator in an oxidized, reduced, or intermediate forms (i.e., various “redox forms”). Accordingly, when a redox mediator is identified in a particular form herein, such identification also includes the corresponding alternative redox forms, each of which would be readily apparent to one skilled in the art.

In the operation of the hydrogen anode half-cell within an electrosynthetic cell that produces one or more desired products, an external electromotive force (EMF) removes electrons from the anode, resulting in the oxidation of the reduced form of the redox mediator. The resulting oxidized form of the redox mediator can then migrate to the heterogeneous redox catalyst, where the oxidized form is converted to the reduced form and the H₂ reductant is simultaneously oxidized to H⁺. The reduced form of the redox mediator may then migrate back to the anode, where the cycle may be repeated.

Because in the disclosed hydrogen anode half-cell, the heterogeneous redox catalyst is not affixed to the anode, the anode itself need not act as a redox catalyst. Thus, the type of electrode used is not limited, and may comprise any electrode material that is typically used in the art.

Within the cathode half-cell, the reductive synthesis catalyst catalyzes the reductive synthesis of the one or more desired chemical products from the one or more chemical reactants. Accordingly, the disclosure encompasses an electrosynthetic cell comprising a cathode half-cell that includes a cathode electrode and a reductive synthesis catalyst that is not affixed to the cathode, along with an electrolyte solution (catholyte) in contact with the electrode and the reductive synthesis catalyst. The catholyte may contain a carbon-containing redox mediator in an oxidized, reduced, or intermediate forms (i.e., various “redox forms”).

In operation, the disclosed electrosynthetic cell comprises a hydrogen anode half-cell paired with a cathode half-cell that is configured for the simultaneous reductive electrosynthesis of one or more desired chemical products from one or more chemical reactants. The reductive electrosynthesis reaction type occurring within the cathode half-cell is not limited, and can include any reductive synthesis reaction that can occur under the given reaction conditions and EMF application.

The anode and cathode half-cells may be separated by a permeable or semi-permeable membrane. The semi-permeable membrane may be a proton-exchange membrane, an anion-exchange membrane, or a membrane designed to facilitate transfer of a specific cation, anion, group of ions, solvent, or group of solvents, depending on the specific species movement desired between half-cells.

### A. Exemplary Carbon-Containing Redox Mediator Used in the Hydrogen Anode

The redox mediator is selected to promote facile hydrogenation, good electrochemistry, optimal solubility in the relevant solvents, and optimal membrane permeability or impermeability.

In some embodiments, the reduced form of the redox mediator is selected from a substituted dihydroxybenzene, substituted hydrazine, substituted hydroxylamine, and a substituted heterocycle, such as a dihydropyridine, dihydroflavin, or dihydroindigo. Preferential substitution of the hydroxyl groups on the dihydroxybenzene include 1,2- and 1,4-substitution.

In embodiments where the reduced form of the redox mediator is a substituted dihydroxybenzene, one or more hydrogen atoms on the ring of the the dihydroxybenzene is substituted with a substituent group. Exemplary substituent groups that could be independently substituted for each hydrogen atom include an alkyl with less than ten carbons, an aryl, fused aryl (e.g. naphthohydroquinone or anthrahydroquinone and derivatives thereof), a fused heteroaryl, a heterocycle, an alkenyl, an alkynyl, a cycloalkyl, an amine, a protonated amine, a quaternary ammonium, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, or a nitro. Additionally, under acidic conditions the substituents (—R groups) on the mediator should be at least partially anionic; and if the solution is basic the substituents should be at least partially cationic.

Exemplary redox mediators where the reduced form is a substituted dihydroxybenzene include, without limitation, anthrahydroquinone-2,7-disulfonic acid, 1,8-dihydroxy-anthrahydroquinone-2,7-disulfonic acid, anthrahydroquinone-2-sulfonic acid, or salts thereof.

In embodiments where the reduced form of the redox mediator is a substituted hydrazine, one or more hydrogen atoms in the hydrazine is substituted with a substituent group. Exemplary substituent groups that could be independently substituted for each hydrogen atom include an alkyl with less than ten carbons, an aryl, a heterocycle, an alkenyl, an alkynyl, a cycloalkyl, an amine, a protonated amine, a quaternary ammonium, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, and combinations of two or more thereof on the same or on different positions on the substituent and at least one of the substituents is charged to increase the aqueous solubility of the hydrazine.

In embodiments where the reduced form of the redox mediator is a substituted hydroxylamine, one or more nitrogen-bound hydrogen atoms in hydroxylamine is substituted with a substituent group. Exemplary substituent groups that could be independently substituted for each hydrogen include an alkyl with less than ten carbons, an aryl, a cycloalkyl, and a bicycloalkyl. In some embodiments, the same substituent group may substitute for two different hydrogen atoms, thus forming a heterocycle. In some embodiments, at least one form of the redox mediator may be a stable radical.

In some embodiments where the reduced form of the redox mediator is a substituted hydroxylamine, one or more of the substituent groups may further include an alkyl with less than ten carbons, an aryl, a heterocycle, an alkenyl, an alkynyl, a cycloalkyl, an amine, a protonated amine, a quaternary ammonium, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, and combinations of two or more thereof on the same or on different positions on the substituent. Additionally, under acidic conditions the substituents (—R groups) on the mediator should be at least partially anionic; and if the solution is basic the substituents should be at least partially cationic.

In some embodiments where the reduced form of the redox mediator is a substituted heterocycle, such as dihydropyridine, dihydroflavin, or dihydroindigo, one or more of the substituent groups may further include an alkyl with less than ten carbons, an aryl, a heterocycle, an alkenyl, an alkynyl, a cycloalkyl, an amine, a protonated amine, a quaternary ammonium, sulfate, a sulfonate, a mercaptoalkylsulfonate, sulfonic acid, phosphate, a phosphonate, a phosphinate, a ketone, an aldehyde, an oxime, a hydrazine, a nitrone, an ether, an ester, a halide, a nitrile, a carboxylate, an amide, a thioether, a fluoroalkyl, a perfluoroalkyl, a pentafluorosulfanyl, a sulfonamide, a sulfonic ester, an imide, carbonate, a carbamate, a urea, a sulfonylurea, an azide, a sulfone, a sulfoxide, an amine oxide, phosphine oxide, a quaternary phosphonium, a quaternary borate, a siloxane, a nitro, and combinations of two or more thereof on the same or on different positions on the substituent. Additionally, under acidic conditions the substituents (—R groups) on the mediator should be at least partially anionic; and if the solution is basic the substituents should be at least partially cationic.

### B. Exemplary Heterogeneous Redox Catalysts Used in the Hydrogen Anode

In some embodiments, the redox catalyst includes one or more metals. In some such embodiments, the one or more metals may include platinum (Pt), palladium (Pd), ruthenium (Ru), cobalt (Co), manganese (Mn), iron (Fe), copper (Cu), vanadium (V), molybdenum (Mo), rhodium (Rh), silver (Ag), gold (Au), tungsten (W), osmium (Os), nickel (Ni), chromium (Cr), or iridium (Ir).

In some embodiments, the catalyst is heterogeneous and in contact with the liquid electrolyte but not in direct physical contact with the electrode.

In some embodiments, the redox catalyst contains a metal that is heterogenized through deposition, adsorption, covalent linking, or otherwise attached to a support.

In some embodiments the support is a carbon-based material, silica, a metal oxide, a metal chalcogenide, a nitride, an oxynitride, a boride, or a carbide.

In some embodiments, the redox catalyst is housed in a reactor through which both the mediator and H₂ flow in order to reduce the oxidized redox mediator and to oxidize the H₂.

### C. Exemplary Reductive Electrosynthesis Reactions Occurring at the Cathode

The hydrogen anode half-cell can be paired with any cathode half-cell that is configured to produce any desired chemical product(s) from one or more chemical reactants by reductive electrosynthesis. The following is a non-limiting review of exemplary reductive electrosynthesis reactions that could occur within the hydrogen anode half-cell. However, the skilled artisan could envision other potential reductive synthesis reactions that could take place within the cathode half-cell.

In some embodiments, the reductive synthesis reaction is a reductive cross-coupling reaction. Non limiting examples include the Ni-catalyzed cross electrophile-coupling of an aromatic halide (Ar—X) with an alkyl or alkenyl halide (R—X) to produce an alkylated or alkenylated aromatic (Ar—R) and halide ion (X⁻). Another example is the Ni/Pd catalyzed cross-coupling of phenol derivatives, such as phenol derivatives produced by lignin depolymerization, to produce asymmetric biaryls. In some such embodiments, the phenol derivatives are converted to sulfonates before the reductive cross-coupling takes place.

In some embodiments, the reductive synthesis reaction is a reductive homo-coupling reaction. Non-limiting examples include the Ni-catalyzed homo-coupling of phenol derivatives, such as phenol derivatives produced by lignin depolymerization, to produce symmetric biaryls. In some such embodiments, the phenol derivatives are converted to sulfonates before the reductive homo-coupling takes place.

In some embodiments, the reductive synthesis reaction is a Birch reduction, where an aromatic ring (substituted or unsubstituted) is converted to an alkene or diene ring.

In some embodiments, the reductive synthesis reaction is a phosphine oxide reduction, where a phosphine oxide is deoxygenated.

In some embodiments, the reductive synthesis reaction is a reductive dimerization.

Non-limiting examples include the electrochemical transformation of acrylonitrile to adiponitrile, pinacol, and McMurray couplings.

In some embodiments, the reductive synthesis reaction is reductive amination. In a non-limiting example, an aryl bromide is coupled with a secondary amine to produce an aryl amine.

In some embodiments, the reductive synthesis reaction is a reductive hindered amine synthesis. In a non-limiting example, a hindered primary amine can be synthesized from the reductive cross-coupling of an imine and an aromatic cyanide.

In some embodiments, the reductive synthesis reaction is a reductive amidation. In a non-limiting example, a secondary amide may be synthesized from a primary amide and an aldehyde.

In some embodiments, the reductive synthesis reaction is a reductive decyanation.

In a non-limiting example, an organic nitrile is transformed into the parent alkane or aromatic compound.

In some embodiments, the reductive synthesis reaction is a reductive dehalogenation.

In some embodiments, the reductive synthesis reaction is a reductive etherification.

In a non-limiting example, ethers are synthesized by combining an aldehyde or a ketone and an alcohol to form the corresponding ether.

In some embodiments, the reductive synthesis reaction is a reductive alcohol synthesis. In a non-limiting example, a carboxyl-containing compound is reduced to the corresponding alcohol.

In some embodiments, the reductive synthesis reaction is a reductive Heck reaction.

In a non-limiting example, the Heck reaction may be used to cross-link an aryl bromide and an olefin.

In some embodiments, the reductive synthesis reaction is a reductive cyclization.

In a non-limiting example, ketoallene may be cyclized by forming a ring junction between the carbonyl carbon of the ketone group the central carbon of the allene group.

In some embodiments, the reductive synthesis reaction is a reductive alkylation.

Although one or more of the previously mentioned reductive reactions are also commonly described as reductive alkylation (e.g., reductive animation), the term applies more broadly to any reaction where an alkyl group is added to an organic substrate.

In some embodiments, the reductive synthesis reaction is a reductive carboxylation reaction. In a non-limiting example, the reaction may be used to link an aryl bromide and CO₂ to generate the corresponding carboxylic acid.

D. Exemplary Organic Solvents for Use in the Cathode and/or Anode

The liquid phase (i.e., electrolyte solution) of the hydrogen anode half-cell (i.e., the anolyte), the cathode half-cell (i.e., the catholyte), or both may include water and/or one or more organic solvents. The solvent mix may be tuned to optimize the desired solubility of the redox mediator, the one or more desired chemical products, and/or the one or more chemical reactants.

Non-limiting examples of organic solvents that could be used in the anolyte or catholyte include acetone, acetonitrile, benzene, 1-butanol, 2-butanol, 2-butanone, t-butyl alcohol, carbon tetrachloride, chlorobenzene, chloroform, cyclohexane, 1,2-dichloroethane, dimethyl carbonate, diethyl carbonate, diethylene glycol, diethyl ether, diglyme (diethylene glycol dimethyl ether), 1,2-dimethoxy-ethane (glyme, DME), 1,3-dimethyl-2-imidazolidinone (DMI), dimethylformamide (DMF), dimethylacetamide (DMA), 1,3-dimethyl-1,3-diazinan-2-one (DMPU), dimethyl sulfoxide (DMSO), 1,4-dioxane, ethanol, ethyl acetate, ethylene glycol, glycerin, heptane, hexamethylphosphoramide (HMPA), methylene chloride, N-methyl-2-pyrrolidinone (NMP), nitromethane, pentane, petroleum ether (ligroine), 1-propanol, 2-propanol, propylene carbonate, pyridine, sulfolane, tetrahydrofuran (THF), 2-methyl tetrahydrofuran toluene, triethyl amine, o-xylene, m-xylene, or p-xylene.

### E. Exemplary Supporting Electrolytes

In some embodiments the anolyte and catholyte contain a supporting electrolyte. Non-limiting examples of supporting electrolytes include lithium chloride, lithium bromide, lithium iodide, lithium hexafluorophosphate, lithium tetrafluoroborate, lithium hexafluoroantinomate, lithium perchlorate, sodium chloride, sodium bromide, sodium iodide, sodium hexafluorophosphate, sodium tetrafluoroborate, sodium hexafluoroantinomate, sodium perchlorate, potassium chloride, potassium bromide, potassium iodide, potassium hexafluorophosphate, potassium tetrafluoroborate, potassium hexafluoroantinomate, potassium perchlorate, tetrabutylammonium chloride, tetrabutylammonium bromide, tetrabutylammonium iodide, tetrabutylammonium hexafluorophosphate, tetrabutylammonium tetrafluoroborate, tetrabutylammonium hexafluoroantinomate, tetrabutylammonium perchlorate, pyridinium chloride, pyridinium bromide, pyridinium iodide, pyridinium hexafluorophosphate, pyridinium tetrafluoroborate, pyridinium hexafluoroantinomate, pyridinium perchlorate, 2,6-lutidinium chloride, 2,6-lutidinium bromide, 2,6-lutidinium iodide, 2,6-lutidinium hexafluorophosphate, 2,6-lutidinium tetrafluoroborate, 2,6-lutidinium hexafluoroantinomate, or 2,6-lutidinium perchlorate.

### Definitions

As used herein, the term “aryl” refers to a carbocyclic aromatic group that is monocyclic or fused (e.g. bicyclic, tricyclic, polycyclic, etc.) containing up to 14 carbon atoms (e.g. C₆-C₁₄-aryl). Examples of aryl groups include phenyl, naphthyl, biphenyl, phenanthrenyl, naphthacenyl, and the like. “Aryl” also contemplates an aryl ring that is part of a fused polycyclic system, such as aryl fused to cycloalkyl as defined herein. An exemplary aryl is phenyl. An aryl group can be unsubstituted or optionally substituted with one or more substituents as described herein (e.g. alkyl).

“Heteroaryl” as defined herein, refers to a monocyclic aromatic ring structure containing 5 to 10, such as 5 or 6 ring atoms, or a bicyclic aromatic group having 8 to 10 atoms, containing one or more heteroatoms independently selected from the group consisting of O, S, and N. Heteroaryl is also intended to include oxidized S or N, such as sulfinyl, sulfonyl and N-oxide of a tertiary ring nitrogen. A carbon or heteroatom is the point of attachment of the heteroaryl ring structure such that a stable compound is produced. Examples of heteroaryl groups include, but are not limited to, pyridinyl, pyridazinyl, pyrazinyl, quinaoxalyl, indolizinyl, benzo[b]thienyl, quinazolinyl, purinyl, indolyl, quinolinyl, pyrimidinyl, pyrrolyl, pyrazolyl, oxazolyl, thiazolyl, thienyl, isoxazolyl, oxathiadiazolyl, isothiazolyl, tetrazolyl, imidazolyl, triazolyl, furanyl, benzofuryl, and indolyl. A heteroaryl group can be unsubstituted or optionally substituted with one or more substituents as described herein.

The term “alkenyl” as used herein, refers to an unsaturated, straight or branched hydrocarbon radical containing at least one carbon-carbon double bond.

The term “alkyl” as used herein, means a saturated, straight or branched hydrocarbon chain radical. In some instances, the number of carbon atoms in an alkyl moiety is indicated by the prefix “C_{x-y}”, wherein x is the minimum and y is the maximum number of carbon atoms in the substituent. Thus, for example, “C₁₋₆ alkyl” means an alkyl substituent containing from 1 to 6 carbon atoms and “C₁₋₄ alkyl” means an alkyl substituent containing from 1 to 4 carbon atoms. Examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 1-methylbutyl, 2-methylbutyl, 3-methylbutyl, 3,3-dimethylbutyl, 1,1-dimethylpropyl, 1,2-dimethylpropyl, 2,2-dimethylpropyl, 1-methylpropyl, 2-methylpropyl, 1-ethylpropyl, and 1,2,2-trimethylpropyl.

The term “cycloalkyl” as used herein, refers to a saturated monocyclic, bicyclic, tricyclic, or polycyclic, 3- to 14-membered ring system, such as a C₃-C₈-cycloalkyl. The cycloalkyl may be attached via any atom. Representative examples of cycloalkyl include, but are not limited to cyclopropyl, cyclobutyl, cyclopentyl, and cyclohexyl. Polycyclic cycloalkyl includes rings that can be fused, bridged, and/or spiro-fused. A cycloalkyl group can be unsubstituted or optionally substituted with one or more substituents as described herein.

“Heterocycloalkyl” as used herein, refers to a saturated or partially unsaturated non-aromatic monocyclic, bicyclic, tricyclic or polycyclic ring system that has from 3 to 14, such as 3 to 6, atoms in which 1 to 3 carbon atoms in the ring are replaced by heteroatoms of O, S or N. Polycyclic heterocycloalkyl includes rings that can be fused, bridged, and/or spiro-fused. In addition, a heterocycloalkyl is optionally fused with aryl or heteroaryl of 5-6 ring members, and includes oxidized S or N, such as sulfinyl, sulfonyl and N-oxide of a tertiary ring nitrogen. The point of attachment of the heterocycloalkyl ring is at a carbon or heteroatom such that a stable ring is retained. Examples of heterocycloalkyl groups include without limitation morpholino, tetrahydrofuranyl, dihydropyridinyl, piperidinyl, pyrrolidinyl, piperazinyl, dihydrobenzofuryl, and dihydroindolyl. A heterocycloalkyl group can be unsubstituted or optionally substituted with one or more substituents as described herein.

The term “haloalkyl” refers to an alkyl group, as defined herein, substituted with one or more halogens. The term “halogen,” “halo,” or “halide,” as used herein, refers to —F or fluoro, —Cl or chloro, —Br or bromo, or —I or iodo.

The term “aryl halide” refers to a compound containing a halide attached to the carbon on the aryl group as defined herein.

The term “heteroaryl halide” refers to a compound containing a halide attached to the carbon on the heteroaryl group as defined herein.

The term “alkenyl halide” refers to a compound containing a halide attached to the alkenyl carbon on the alkenyl group as defined herein.

The term “alkyl halide” refers to a compound containing a halide attached to the carbon on the alkyl group as defined herein.

The term “cycloalkyl halide” refers to a compound containing a halide attached to the carbon on the cycloalkyl group as defined herein.

The term “heterocycloalkyl halide” refers to a compound containing a halide attached to the carbon on the heterocycloalkyl group as defined herein.

The term “alkoxy” as used herein means an alkyl group, as defined herein, appended to the parent molecular moiety through an oxygen atom. Representative examples of alkoxy include, but are not limited to, methoxy, ethoxy, propoxy, 2-propoxy, butoxy, tert-butoxy, pentyloxy, and hexyloxy. In some instances, the number of carbon atoms in an alkoxy moiety is indicated by the prefix “C_{x-y}”, wherein x is the minimum and y is the maximum number of carbon atoms in the substituent. Thus, for example, “C₁₋₆ alkoxy” means an alkoxy substituent containing from 1 to 6 carbon atoms and “C₁₋₄ alkoxy” means an alkoxy substituent containing from 1 to 4 carbon atoms.

The term “haloalkoxy” as used herein, refers to an alkoxy group as defined herein that is substituted with one or more halogens as defined herein.

The term “hydroxy” refers to the group —OH.

The term “thioether” refers to a group containing a sulfur atom attached to two same or different alkyl, cycloalkyl, hereocycloalkyl, aryl, or heteroaryl groups as defined herein.

The term “sulfonate” as used herein, refers to a salt or an ester of a sulfonic acid R—S(O)₂OH, wherein the R group is an organic group such as aryl, alkyl, cycloalkyl, etc., as defined herein. When the term “sulfonate” refers to a salt, the “sulfonate” has a formula of —SO₂OR′, wherein R′ is a countercation. In some embodiments, the countercation is a cation derived from a Group 1A, 2A, or 3A metal. For example, R′ may be a Na⁺ cation or a Mg²⁺ cation.

The term “alkali carbonate base” refers to a carbonate base containing an alkali metal cation. For example, the alkali carbonate base may be lithium carbonate, sodium carbonate, potassium carbonate, cesium carbonate, etc.

The term “reductive C(sp²)-C(sp³) coupled product” refers to a chemical product of a reductive coupling synthesis, wherein the new bond formed in the product is formed between a sp²-hybridized carbon in one of the reactants and a sp³-hybridized carbon in the same reactant or another reactant. In general, a sp²-hybridized carbon is a ring carbon on an aryl or a heteroaryl group, or an alkenyl carbon of an alkenyl group. A sp³-hybridized carbon is a carbon on an alkyl group, or a ring carbon on a cycloalkyl or a heterocycloalkyl group.

As used herein, the term “electromotive force” refers to the maximum potential difference between two electrodes of a cell.

The term “current density” refers to the amount of electric current flowing per unit cross-sectional area of a material.

The following example is offered for illustrative purposes only, and does not limit the scope of the present invention in any way. Indeed, various modifications in addition to those shown and described herein will become apparent to those skilled in the art from the foregoing description and the following example, and fall within the scope of the appended claims.

### Example: Electrosynthetic Cell with Hydrogen Anode and Cathode Configured for Reductive Electrosynthesis

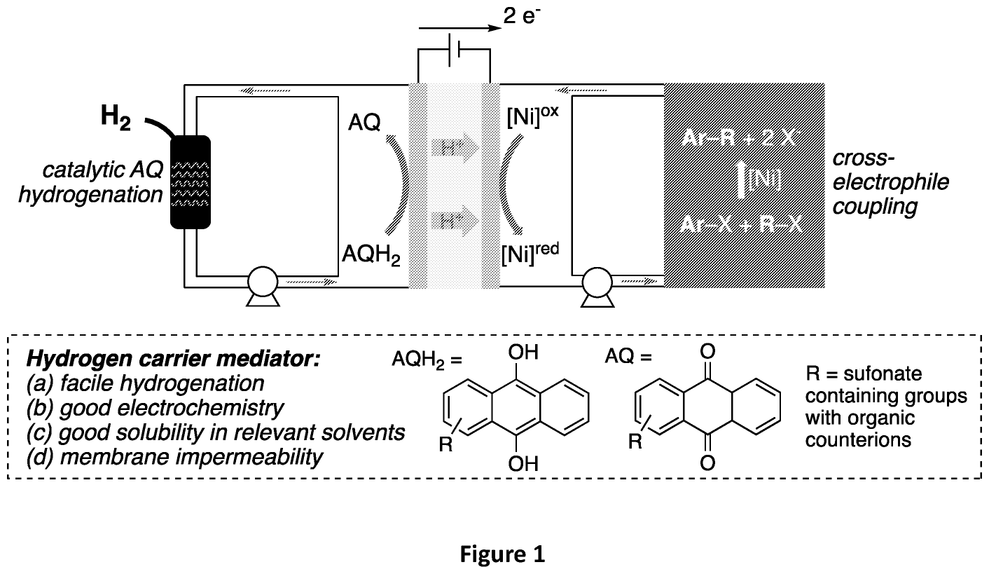

FIG. 1 depicts a general scheme for an electrosynthetic cell incorporating a flow-based hydrogen anode half-cell and a cathode half-cell configured for reductive electrosynthesis by Ni-catalyzed cross-electrophile coupling.

In a non-limiting example, the hydrogen anode half-cell includes an electrolyte organic solvent and a sulfonated anthraquinone (AQ)/anthrahydroquinone (AQH₂) redox mediator pair, such as anthraquinone-2,7-disulfonic acid disodium salt and anthrahydroquinone-2,7-disulfonic acid disodium salt.

An externally applied EMF removes electrons from the anode, which is in contact with the electrolyte. This results in the oxidation of the AQH₂ to AQ. The AQ then migrates through the electrolyte to the heterogeneous redox catalyst, which is being contacted with an H₂ feed, resulting in the catalytic hydrogenation (reduction) of the AQ to AQH₂ and the simultaneous oxidization of the H₂ to H⁺. As a non-limiting example, the heterogeneous catalyst may include Pt supported on carbon (Pt/C).

The resulting AQH₂ then migrates back to the anode, where it is oxidized back to AQ, and this cycle can be continuously repeated as more H₂ is oxidized to H⁺. As shown in FIG. 1, excess H⁺ ions can migrate through semipermeable membranes to balance the charge/ion production occurring within the cathode half-cell.

The cathode half-cell includes a liquid phase containing an organic solvent and a supporting electrolyte, one or more chemical reactants (in this case, an alkyl halide R—X and an aromatic halide Ar—X), and a nickel catalyst. The anode half-cell also includes a supporting electrolyte.

In operation, the externally applied EMF adds electrons to the cathode. This results in the reduction of the Ni at the electrode from an oxidized to a reduced form. The reduced form of Ni catalyzes the reductive cross-electrophile coupling of Ar—X and R—X to form Ar—R, the desired chemical product, along with halide ion (X⁻). The Ni catalyst is simultaneously oxidized back to its oxidized form, and the cycle can be continuously repeated.

### I. GENERAL CONSIDERATIONS

All reagents were purchased from commercial sources and used as received. Ni salts, ligands, and sodium anthraquinone monosulfate were purchased from Sigma-Aldrich. Aryl and Alkyl halide substrates were purchased from Oakwood, Combi-Blocks, TCI America, Chem-Impex, Ambeed, Enamine, AK Scientific, and Sigma-Aldrich. Anhydrous organic solvents were purchased from Sigma-Aldrich and Acros in sure seal or acros seal bottles and stored in a nitrogen filled glove box. Lithium carbonate, sodium carbonate and potassium carbonate were purchased from Sigma Aldrich. 5% b/w palladium on carbon and other heterogenous hydrogenation catalysts were purchased from Sigma Aldrich unless otherwise indicated. 4-(Acetylamino)-2,2,6,6-tetramethyl-1-oxo-piperidinium tetrafluoroborate (Bobbitt's Salt) was purchased from Sigma Aldrich. TMSCl, bis(trimethylsilyl)acetamide, and Hunig's base were purchased from Sigma Aldrich. Hydrogen was purchased from AirGas (UHP grade). di-tert-Butyl and dtbbpy refers to 4,4′-di-tert-butyl-2,2′-bipyridine. 4-tert-Butyl terpyridine, ttbtpy, and ^{tBu}tpy refer to 4,4′,4″-tri-tert-butyl-2,2′:6′,2″-terpyridine. SM is sometimes used as an abbreviation for “starting material”. All reaction solids were weighed out on the benchtop or in a nitrogen filled glovebox, solvents were added in a nitrogen-filled glovebox or a simple nitrogen glovebox without a catalyst bed. Disposable vials and Teflon lined screw caps were purchased from Chemglass. 10 mL pyrex microwave vials for gas uptake measurements were purchased from CEM. Gas uptake measurements where taken on a custom-built parallel gas uptake apparatus previously reported. [Salazar, C. A. et al. Multichannel Gas-Uptake/Evolution Reactor for Monitoring Liquid-Phase Chemical Reactions. Rev. Sci. Instrum. 2021, 92, 044103.] LC-MS data were collected using a Waters ACQUITY UPLC I-Class PLUS equipped with an ACQUITY PDA detector and QDa Detector. ACQUITY UPLC BEH C18 columns were used for the UPLC separations. Samples were prepared in 96 well plates with 350 μL purchased from analytical sales and services. UPLC-MS mobile phases consisted of either water/MeCN with 0.1% by formic acid or water/9:1 MeCN:water with 0.005 M ammonium formate as an additive. UPLC-MS methods were either 2 or 4 minutes long and began with 10% MeCN and 90% water with a 1.5 or 3.5 minute ramped gradient to 100% MeCN, this was held for 20 seconds before the mobile phase was adjusted back to 10% MeCN and 90% water which was held for 10 seconds to prepare for the next injection. UPLC-MS data was analyzed using empower. UPLC grade MeCN was purchased from Sigma-Aldrich, water was purified using a milliQ purification system. ¹H, ¹³C, and ¹⁹F NMR spectra were recorded on a Bruker Avance III 400 spectrometer at 25° C. (H 400.1 MHz, ¹³C 100.6 MHz, ¹⁹F 376.5 MHz) or a Bruker Avance III 500 spectrometer at 25° C. (¹H 500.1 MHz, ¹³C 125.7 MHz, ¹⁹F 470.6 MHz), except where noted otherwise, and chemical shifts are reported in parts per million (ppm) (NSF-CHE-1048642). NMR spectra were absolutely referenced to CHCl₃ at 7.26 ppm (¹H) and CDCl₃ at 77.16 ppm (¹³C). Data for ¹H NMR are reported as follows: chemical shift (δ ppm), integration, multiplicity (s=singlet, d=doublet, t=triplet, q=quartet, m=multiplet), and coupling constant (Hz). Data for ¹³C NMR are reported in terms of chemical shift and no special nomenclature is used for equivalent carbons. In instances where coupling to heteronuclei is observed ¹³C NMR are reported as follows: chemical shift (δ ppm), multiplicity (s=singlet, d=doublet, t=triplet, q=quartet, m=multiplet), and coupling constant (Hz). Organic solutions were concentrated under reduced pressure on a Buchi rotary evaporator using a water bath set to 30° C. NMP was removed under reduced pressure in a Thermo Scientific Savant SpeedVac Concentrator at 70° C., or via distillation under high vacuum. Chromatography was performed using an automated Biotage Isolera® with Silicycle SiliaSep® Premium Flash Cartridges, with ACS reagent grade EtOAc and pentane purchased from Sigma Aldrich. High-resolution mass spectra were obtained using a Thermo Q Exactive™ Plus via ASAP-MS by the mass spectrometry facility at the University of Wisconsin (NIH—1S10OD020022-1).

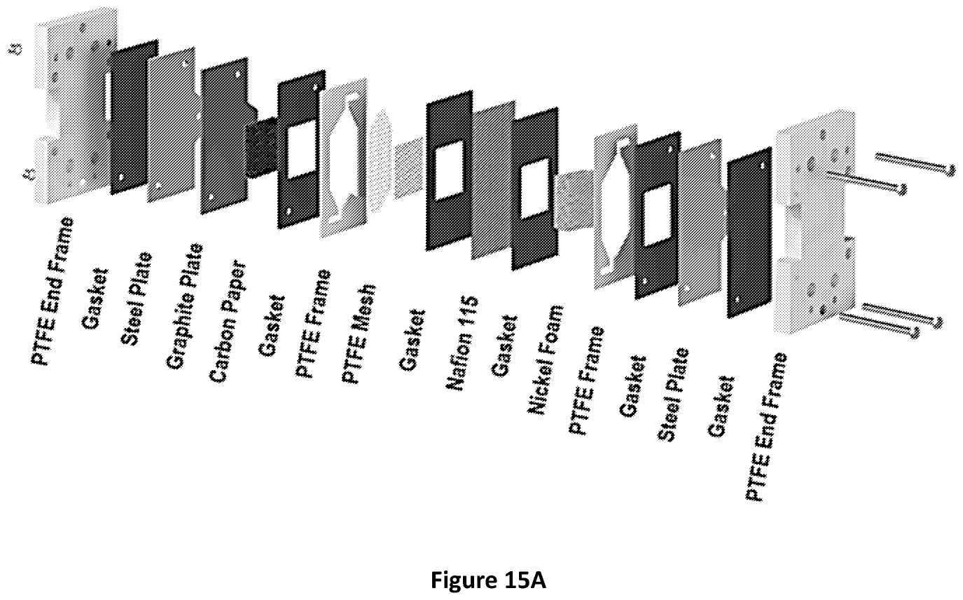

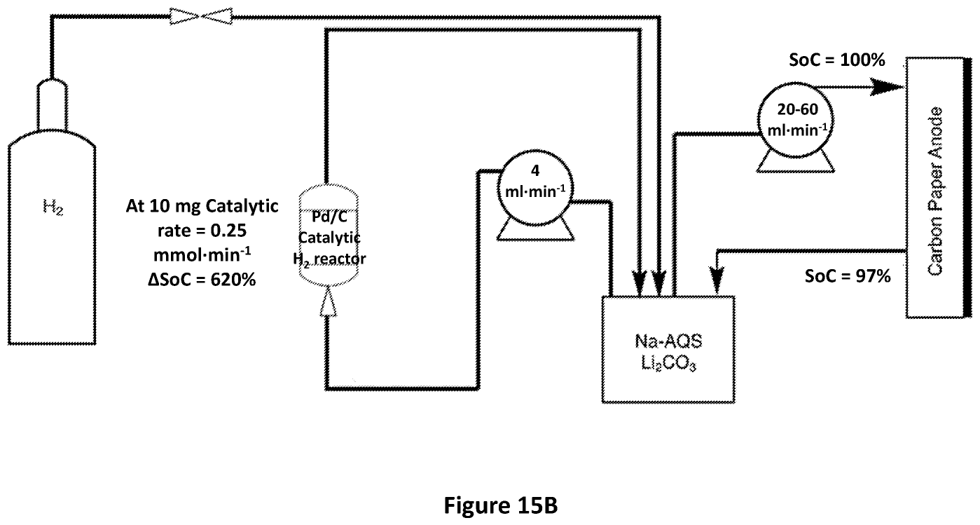

Electrochemical reactions were driven using either a BASi Epsilon Potentiostat, CH Instruments Electrochemical Analyzer, Bio-Logic SAS BP300 Potentiostat, or a XP PLS1500 power supply. Nafion 115 was purchased from Fuel Cell Store as a 15 cm×15 cm sheet and cut to size. Nafion 117 was purchased cut to size from Electro Syn Nickel foam (1.6 mm thickness, 95% porosity) was purchased from MTI corporation and cut to size, or purchased for Electro Syn cut to size. RVC was purchased from Ultramet and cut to size. Carbon paper (without the addition of a hydrophobic layer) was purchased from sigracet and cut to size. Divided H-cells were constructed at the University of Wisconsin Madison Chemistry Department glass blowing facility from 2 Ace glass 7646-06 O-ring seal joints (9 mm) and 2 a 14/20 joints. Gram scale flow experiments and H₂ anode bench marking where conducted in Micro Flow Cell purchased from Electrocell. 100 gram scale reactions were conducted in a Electro Syn Cell purchased from Electrocell. Cole-Palmer gear and peristaltic pumps where used to recirculate the anolyte and catholyte through the Syn Cell and Micro Flow Cell respectively. For gram scale reactions a Hitachi L-6200 Intelligent pump was used to circulate the anolyte through the packed bed reactor. For schematic of Electrosyn micro cell used for mediated H₂ anode synthesis on gram scale, see FIG. 15A. For schematic for parallel flow set-up, see FIG. 15B.

### II. MEDIATOR AND HYDROGEN CATALYST OPTIMIZATION

### Synthesis of Mediators

### Electrochemical Evaluation of Potential Mediators

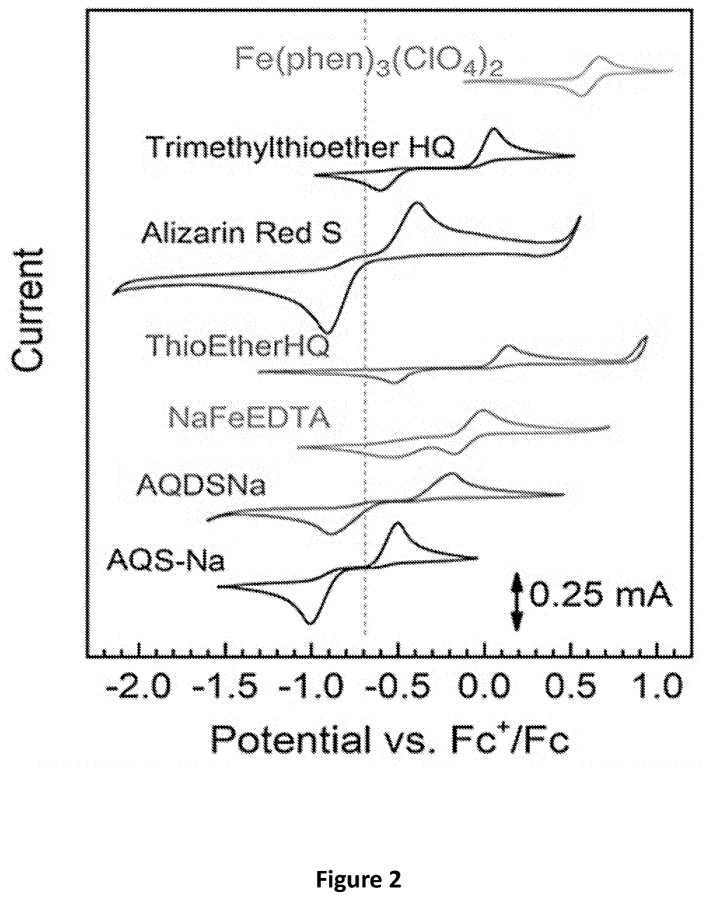

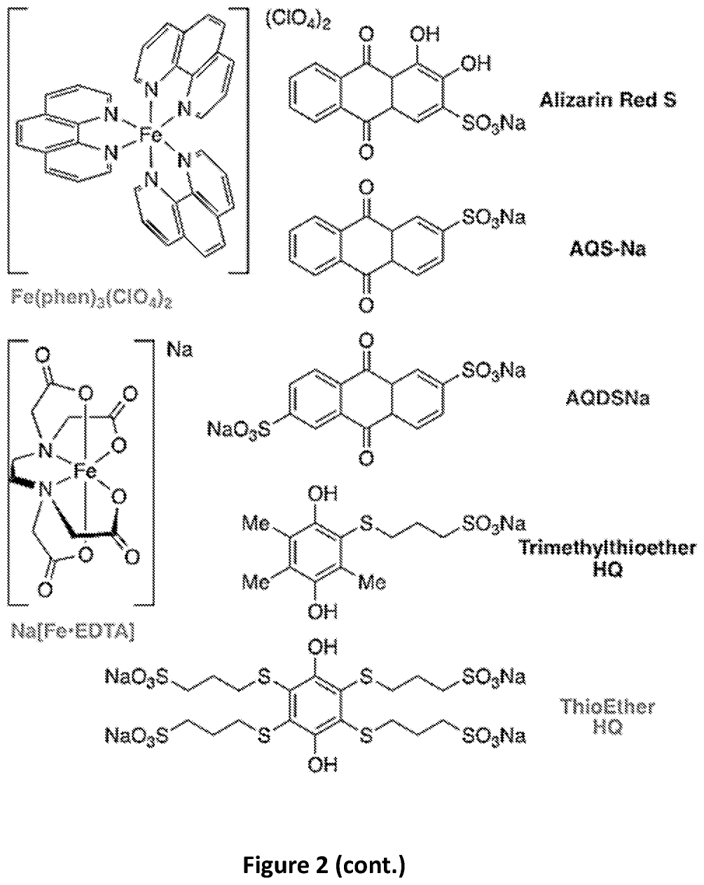

Cyclic Voltammograms (CV) of potential mediators were measured to determine their reduction potentials, and gauge the electrochemical reversibility of these redox features in the polar aprotic solvent dimethylformamide (DMF) (FIG. 2). Optimal mediators were selected for further evaluation on the basis of low measured redox potential and small peak-to-peak separation.

### Evaluation of Hydrogenation Catalysts for Mediator Hydrogenation

Supported metal catalysts were evaluated for the reduction of the Na-AQS, trimethylthioether HQ and ThioEther HQ mediators. The scheme below is representative of a general reaction, with deviations from the noted parameters listed where appropriate. Catalytic activity was assessed through measurement of hydrogen uptake.

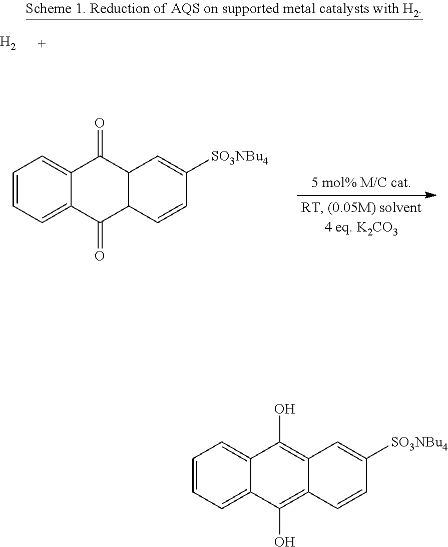

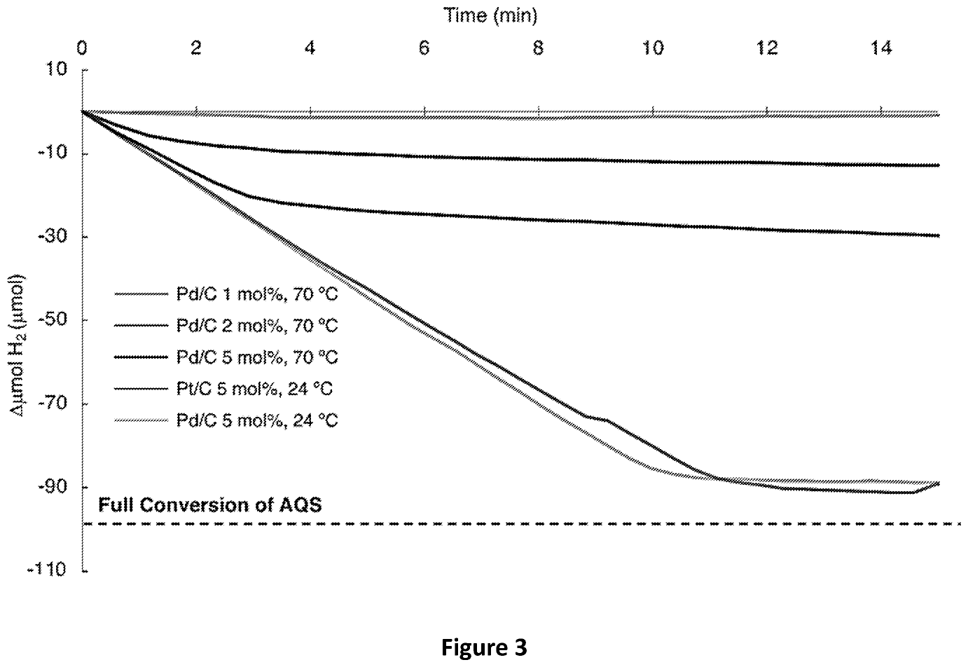

The solid catalyst (5 mol % metal, 0.005 mmol) and potassium carbonate (55.28 mg, 0.4 mmol, 4 equiv.) were weighted into thick-walled microwave vials fitted with oval shaped stir bars. The microwave vial was then fitted to a pressure transduced and sealed against atmosphere. The vial was evacuated and backfilled with H₂ times before being sealed and allowed to equilibrate in a temperature controlled ceramic block for 10 minutes. In a 20 mL vial was added Na-AQS (310.26 mg, 1 mmol), and DMF (20 mL, 0.05 M). The vial was then sealed with a teflon lined screw cap and sparged with N₂ for 20 minutes. At this point pressure change data began recording. A 2 mL aliquot of the 50 mM AQS solution was withdrawn and was added to each tube through a thick rubber septum. Magnetic stirring was begun (1200 RMP) and the pressure was monitored until it had equalized. The moment of solution injection was noted as a visible pressure spike on the uptake traces and was used as the starting point for the reaction. A decrease in pressure was measured and correlated to consumption of hydrogen. This method was used to screen catalyst identity, catalyst loading, and optimal reactor temperature FIG. 3.

Both Pd/C and Pt/C catalysts demonstrated rapid rates of AQS hydrogenation, achieving quasi-complete conversion within fifteen minutes. Pd/C was identified as optimal due to its lower cost. At higher temperatures, however, the initial rate remained unchanged, but reactivity ceased well before complete substrate reduction. Reduction of the catalyst loading showed progressively earlier cessation of hydrogen consumption. These data, suggest that the catalyst tolerates the AQS solution in DMF at room temperature, at least for short durations, but that it is deactivated at elevated temperature. For this reason, and given the sufficient RT reactivity, we chose to operate our reactor bed at room temperature.

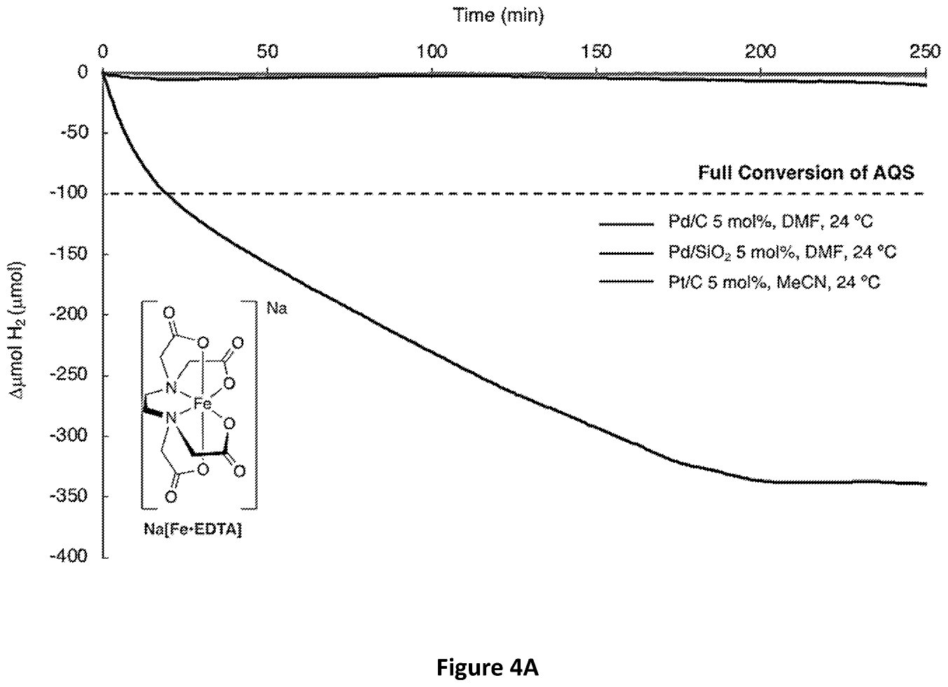

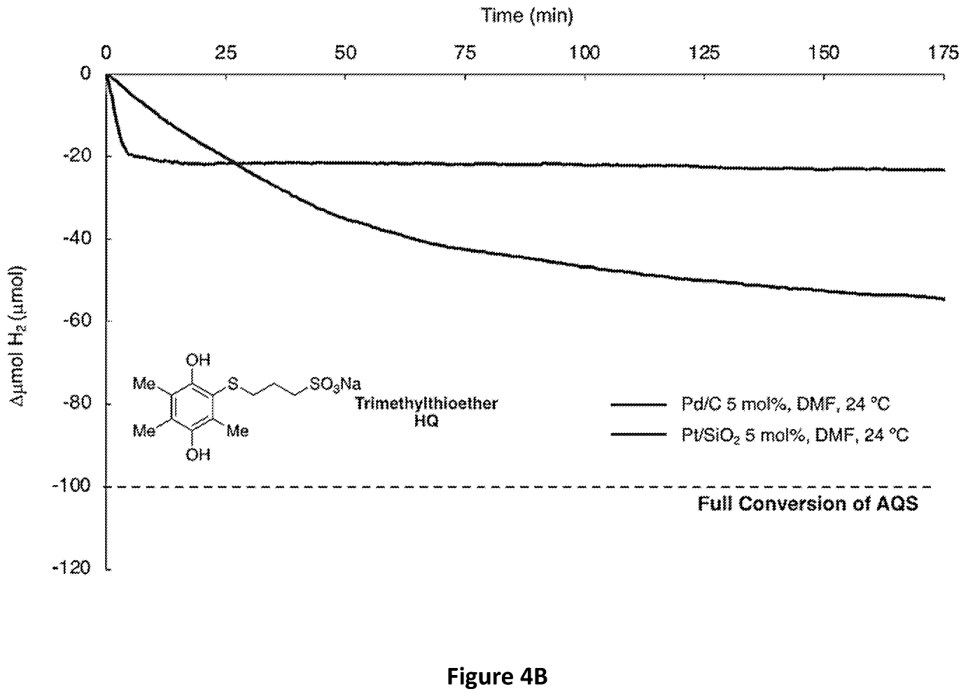

Other catalysts and mediators were evaluated. Na(Fe·EDTA) was reducible by hydrogen, but the reduction was slow relative to other mediator/catalyst pairings and exhibited non-standard reaction kinetics. TMT HQ screens showed premature reaction cessation in all cases, suggesting that either the catalysts or mediator were de-activating during the reaction. (This may be a result of lability of the thioether group). Pd/SiO₂ was evaluated as a catalyst in both DMF and MeCN as solvent. The Pd/SiO₂ catalyst showed reduced rates for quinone-based mediators compared to Pd/C. Acetonitrile was directly hydrogenated under these conditions and the reaction byproducts poison the catalyst and prevent further reactivity. This data is summarized in FIG. 4A-4B.

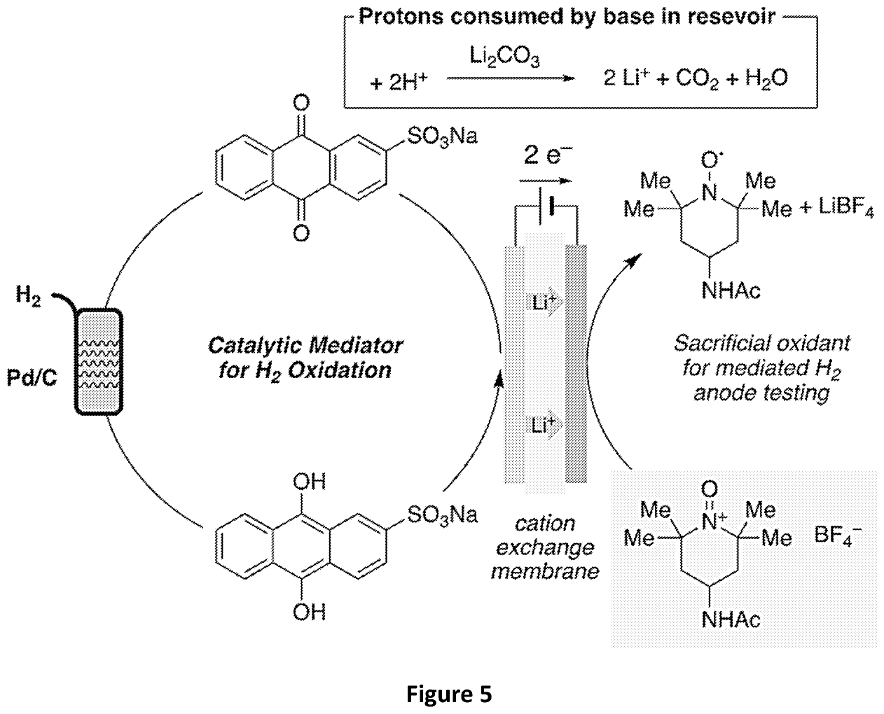

To determine achievable current densities using this embodiment of the mediated H₂ Anode system, a simple robust cathodic reaction was identified. The electrochemical reduction of the readily available oxoammonium species Bobbitt's salt was used due to its low thermodynamic barrier to reduction, high solubility, and low cost (FIG. 5).

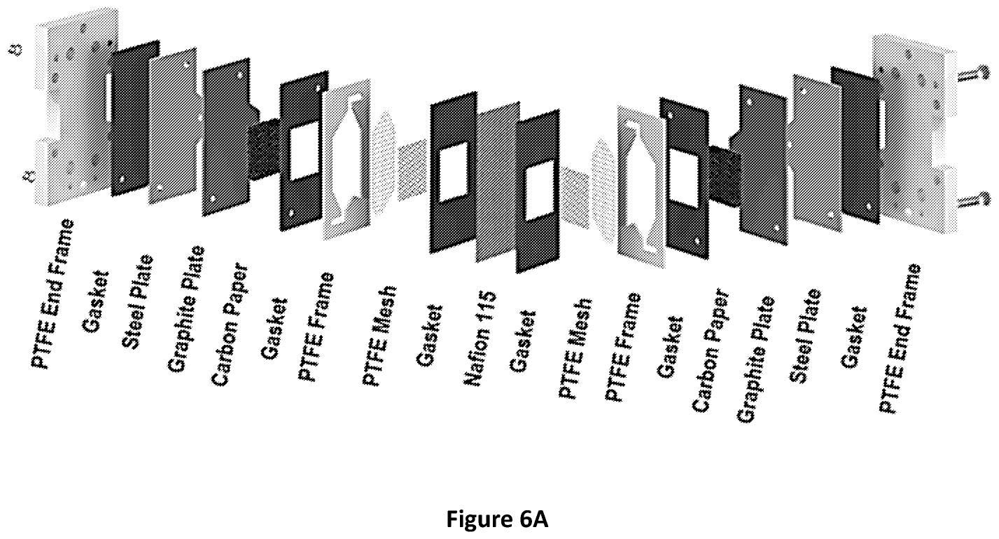

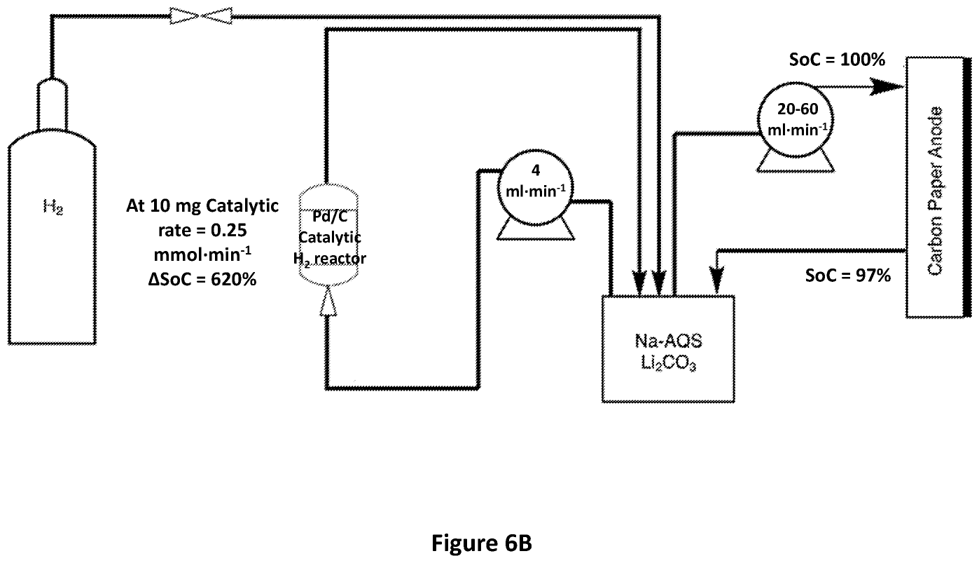

An Electrocell micro flow cell was used as the flow apparatus. The flow cell consisted of a Nafion 115 cation exchange membrane, a 5 cm² carbon paper anode distanced from the membrane with a PTFE screen, a 5 cm² carbon paper cathode distanced from the membrane with a PTFE screen, and two PTFE flow frames, with incompressible components separated by Viton gaskets. Typically, these data were collected while maximizing parameters that would enable maximum attainable currents. Hence, the concentration of Na-AQS in the anolyte was 0.3 M (5.58 g, 18 mmol) with 0.4M NBu₄BF₄ (7.9 g, 24 mmol 0.4 M) as supporting electrolyte, in 60 mL NMP (near the solubility limit of Na-AQS in NMP)—a large excess of Li₂CO₃ was supplied for the purpose of the experiment. The catholyte consisted of 0.6 M Bobbitt's salt (3.6 g, 12 mmol) and 0.4 M NBu₄BF₄ (2.63 g, 8 mmol) as the supporting electrolyte in 20 mL NMP, matching the faradaic capacity of the two solutions. The flow rate through the cell was 80 mL/min. Bobbitt's salt was readily reduced on a carbon paper electrode, leading to a symmetrical cell design (FIG. 6A-6B).

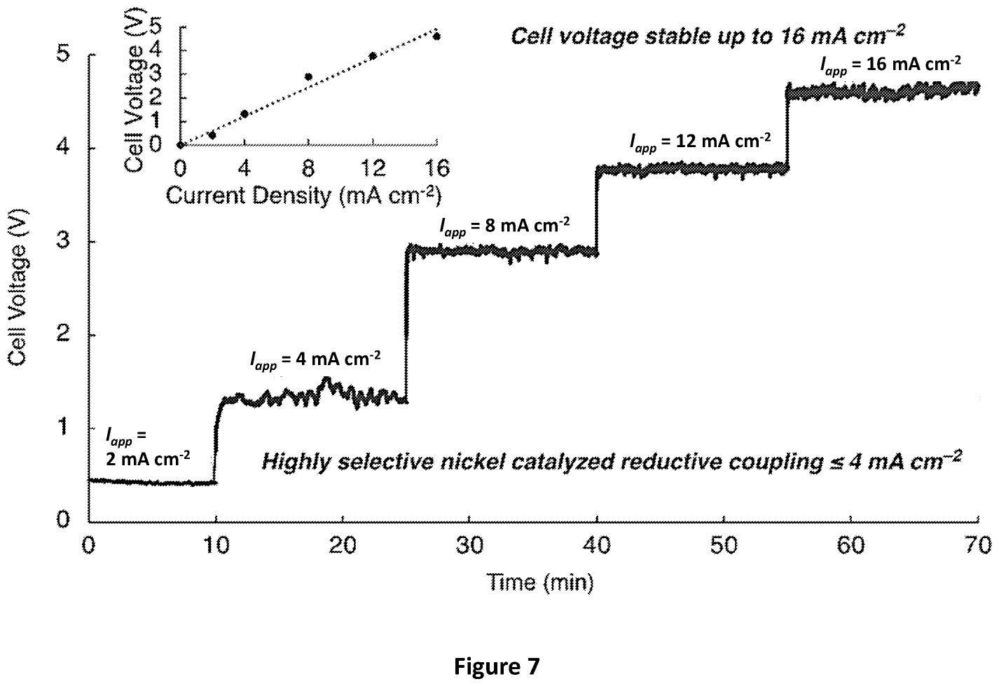

The packed bed hydrogenation reactor (2.2 in length, 0.5 in OD) was made from a stainless-steel tube with 5 wt. % Pd/C (50 mg, 0.023 mmol) retained using 1 inch of glass wool on each end. The anolyte solution, catholyte solution, and catalytic packed bed were prepared prior to operation. 2 24/40 rubber septa were punctured with a 14 gauge need and Teflon tubing (⅛ in ID and 3/16 in OD) were threaded though the septa. This Teflon tubing was fitted with HPLC frits. To a 100 mL 3 neck 24/40 round bottom flask with an oval stir bar was added AQS (5.58 mg, 18 mmol), and Li₂CO₃ (665 mg, 9 mmol) and NMP (60 mL). 2 of the openings were fitted with the septa fitted with the frits, the final opening was fitted with an unmodified 24/40 rubber septa, before stirring the solution for 20 minutes. H₂ was then vigorously bubbled through a 22 g needle into the solution to allow for hydrogen saturation of the solution. To a separate 50 mL round bottom flask fitted with an oval shaped stir bar was added Bobbitt's salt (3.6 g, 12 mmol), NBu₄BF₄ (2.63 g, 8 mmol) and NMP (20 mL). This vessel was sealed with a rubber septum and placed under nitrogen atmosphere via head space purge for 20 minutes. The catholyte was stirred for 10 minutes to ensure homogeneity. In the catalytic hydrogenation reactor, the AQS was reduced to anthrahydroquinone-2-sulfonate (AQS-H₂) and the anolyte then flowed back into the reservoir. After 45 minutes, a second flow loop used a peristaltic pump to cycle anolyte and catholyte through the electrochemical flow cell was started. In ideality the AQS-H₂ was oxidized on the carbon anode to form AQS and protons. The protons, separated from the proton exchange membrane by a PTFE screen, were carried back into the reservoir. Protons were prevented from accumulating by reaction with Li₂CO₃ in the anodic reservoir. On the cathode Bobbitt's salt is reduced. During electrolysis, a constant current was applied to the cell for each condition and was held constant for 15 minutes. Over this period, the cell voltage was measured and, where stable, was used as an indicator that the system was supplying electrons at the rate being tested. After each stable cell voltage, the applied current was increased. As depicted in FIG. 7, the cell voltage was stable at all measured current densities between 2-16 mA·cm⁻² (10-80 mA applied current). Each increase in potential led to a concomitant increase in cell voltage; as shown in the inset, these increases are consistent with Ohmic losses due to fixed resistance within the system. Having established a range of operating current densities we next sought to establish the viability of the use of this mediated H₂ anode to drive Ni-catalyzed cross-electrophile coupling.

### III. OPTIMIZATION OF NICKEL CATALYZED CROSS ELECTROPHILE COUPLING

### General Procedure for Reaction Optimization in a Divided H-Cell

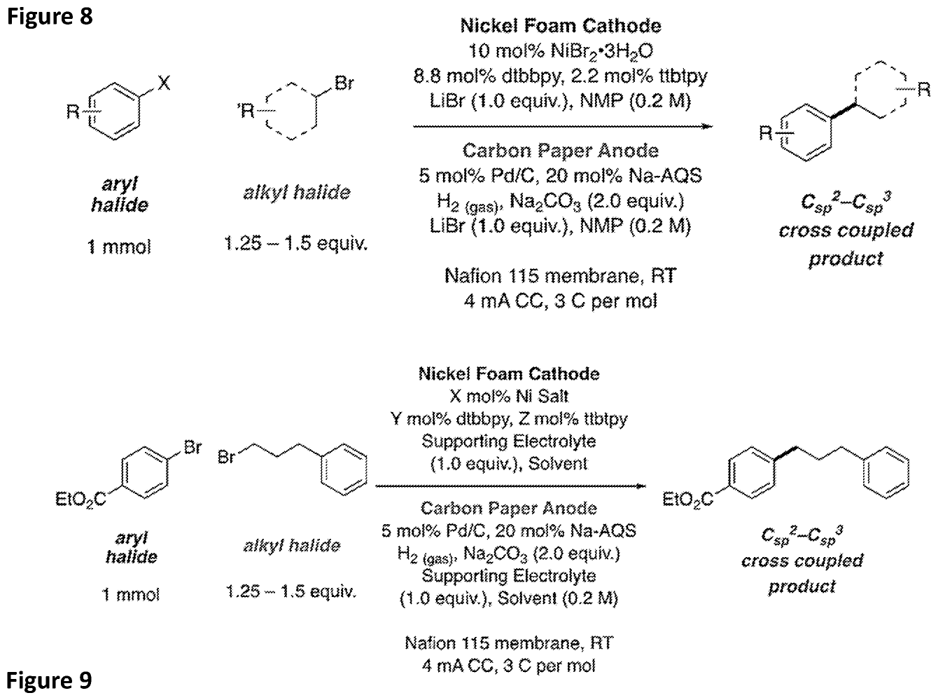

FIG. 8 illustrates and exemplary Ni-catalyzed cross electrophile coupling of ethyl 4-bromobenzoate and 1-bromo-3-phenylpropane used for reaction optimization.

In a nitrogen filled glove box, to a 6-dram vial fitted with a cross shaped stir bar and a Teflon lined cap was added supporting electrolyte (4 mmol) and solvent (20 mL). The mixture was stirred in a glove box until complete dissolution of the electrolyte. This vial was then removed from the glove box and placed under positive pressure on nitrogen on a Schlenk line. A 2.5×2.5 cm square of Nafion 115 was cut and placed in a small beaker. A 1 mL aliquot of the 0.2 M electrolyte solution was removed under positive pressure of nitrogen and used to soak the Nafion membrane for 10 minutes. A divided H-cell was then assembled around the Nafion membrane using a Viton O-ring and ring clamp to secure the cell. Each chamber of the cell was fitted with a cross shaped stir bar. To the anodic chamber was added 5% b/w palladium on carbon (42 mg, 0.02 mmol, 2 mol %), sodium anthraquinone monosulfate (Na-AQS) (62 mg, 0.2 mmol, 20 mol %), and Na₂CO₃ (210 mg, 2 mmol, 2 equiv.). A 5 cm×1×0.5 cm rectangle of RVC was cut using a razor blade and affixed to copper wire. A 14/20 rubber septum was punctured with a 14-gauge needle and the copper wire (with RVC electrode) was threaded through the rubber septum before removal of the needle. The RVC electrode was then placed in the anodic chamber roughly 5 mm above the stir bar and the 14/20 joint sealed with the rubber septum.

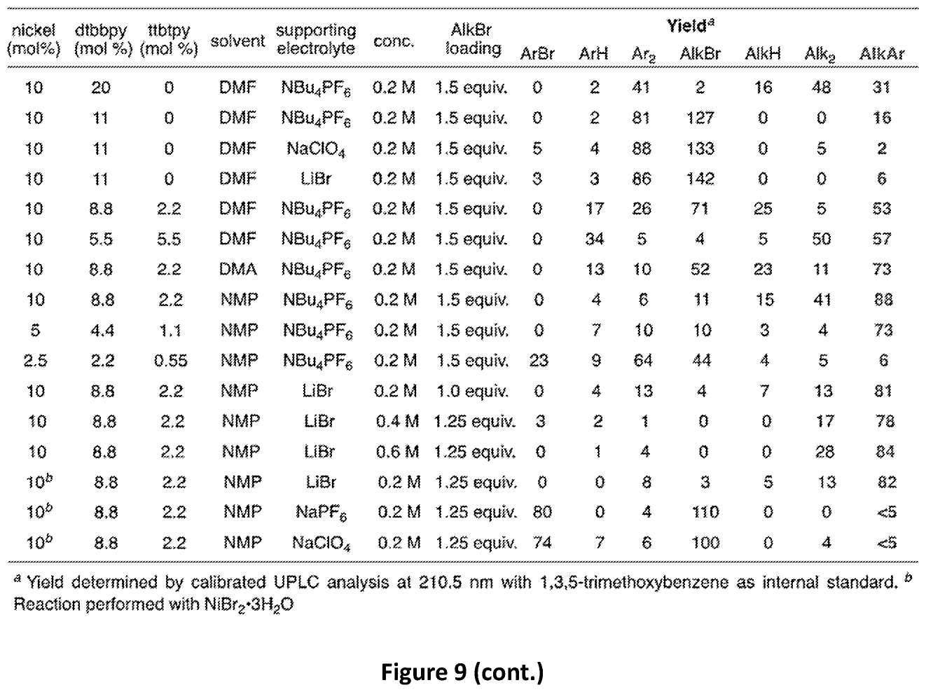

FIG. 9 illustrates an exemplary Ni-catalyzed cross-electrophile coupling of ethyl 4-bromobenzoate and 1-bromo-3-phenylpropane.

To the cathodic chamber was added NiBr₂·3H₂O (27.3 mg, 0.1 mmol, 10 mol %), dtbbpy (varying quanitites), and ttbtpy (varying quantities). A 2×4 cm rectangle of nickel foam was cut and affixed to copper wire (folded over the wire and crimped with a pair of plyers). A 14/20 rubber septum was punctured with a 14-gauge needle and the copper wire (with nickel foam electrode) was threaded through the rubber septum before removal of the needle. The nickel foam electrode was then placed in the cathodic chamber roughly 5 mm above the stir bar and the 14/20 joint sealed with the rubber septum. The head space of chamber of the H-cell was cleared via nitrogen flush for 10 minutes. The anodic compartment head space was then cleared with hydrogen gas for 10 minutes. 5 mL of the electrolyte in solvent solution was withdrawn using a syringe and added to the cathodic compartment under nitrogen atmosphere. 7.5 mL of the electrolyte in solvent solution was withdrawn using a syringe and added to the anodic compartment. The hydrogen purge needle was submerged under the surface of the solution and hydrogen flow rate adjusted to provide roughly one bubble per second, the anolyte and catholyte were stirred at 600 RPM until complete dissolution of the catholyte. At this stage ethyl 4-bromobenzoate (1 mmol, 1.0 equiv) and 1-bromo-3-phenylpropane (varying quantities) were added to the catholyte via Hamilton syringe. The copper wires were attached to a BASi Epsilon or CH instruments potentiostat with the cathode identified as working electrode and the anode as counter and reference electrode. Constant current electrolysis was performed until 3.5 F/mol had passed, or until the cell potential reach −10 V. Upon completion of the reaction the catholyte was transferred via Eppendorf pipette to a 4 dram vial. The cathode and cathode chamber was rinsed with MeCN and these rinsing were transferred to the vial. 1,3,5-Trimethoxybenzene (84 mg, 0.5 mmol. 0.5 equiv) was added to the vial as internal standard. Either a 2 mL aliquot was removed and diluted into 200 mL 3:1 mixture of MeCN/DMSO for UPLC-MS analysis. Or a 50 mL aliquot was removed and diluted into 500 mL of d³-MeCN for ¹H NMR analysis. A 400 mHz instrument was used with a delay time of 6 seconds with 32 scans.

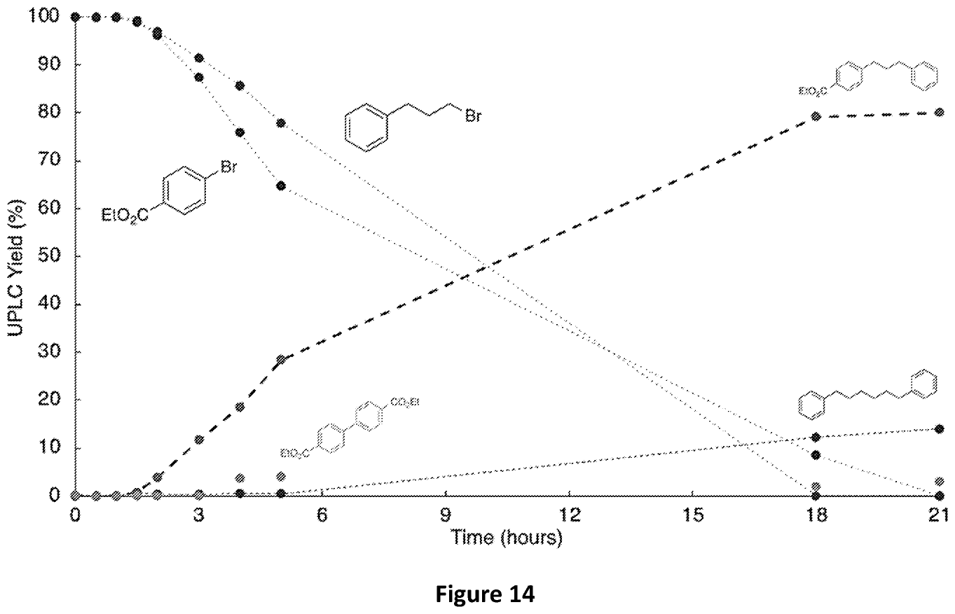

For time course data for the Ni-catalyzed cross electrophile coupling of 1-bromo-3-phenylpropane and ethyl-4-bromobenzoate under optimized conditions, see FIG. 14.

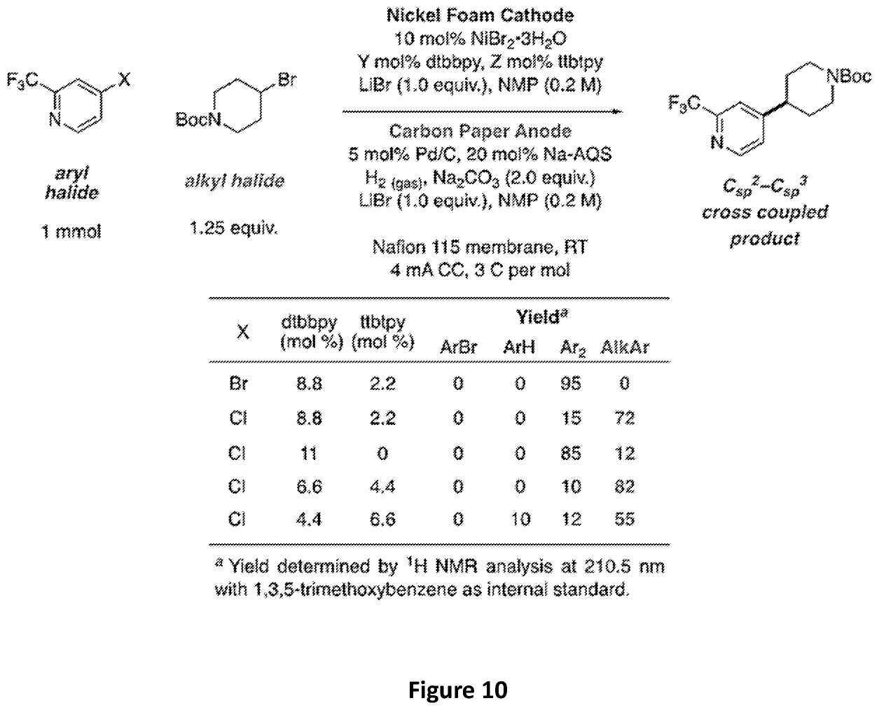

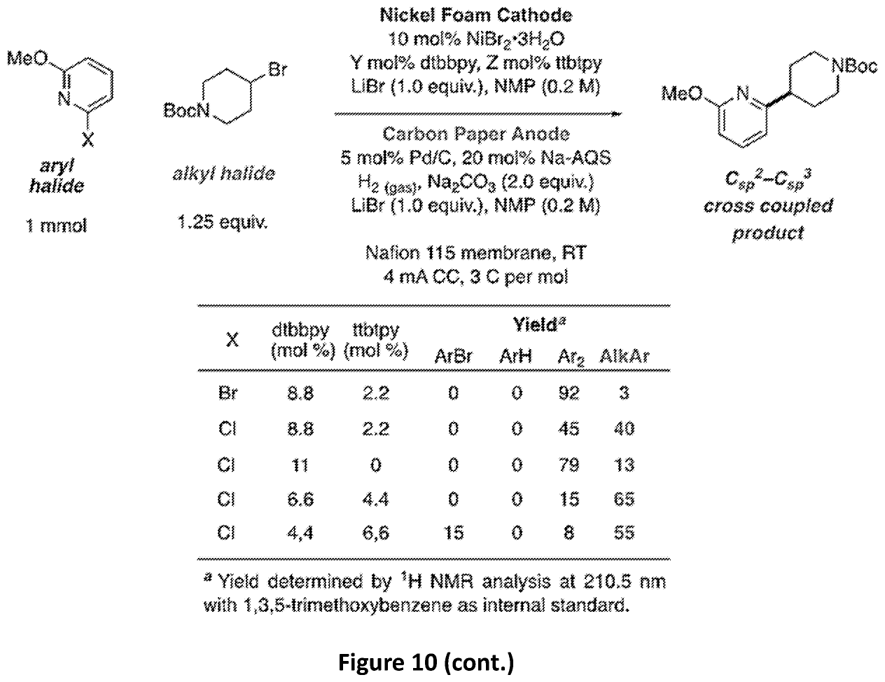

An optimal catalyst composition of 8.8 mol % dtbbpy and 2.2 mol % ttbtpy with 10 mol % NiBr₂·3H₂O was identified for aryl bromides. Activated heteroaryl bromides undergo undesired homodimerization of the aryl halide substrates using this catalyst system. Activated heteroaryl chlorides can be cross-coupled via this methodology but require adjustments in ligand ratios. We attribute these result to differential rates of oxidative addition for activated heteroaryl halides (FIG. 10).

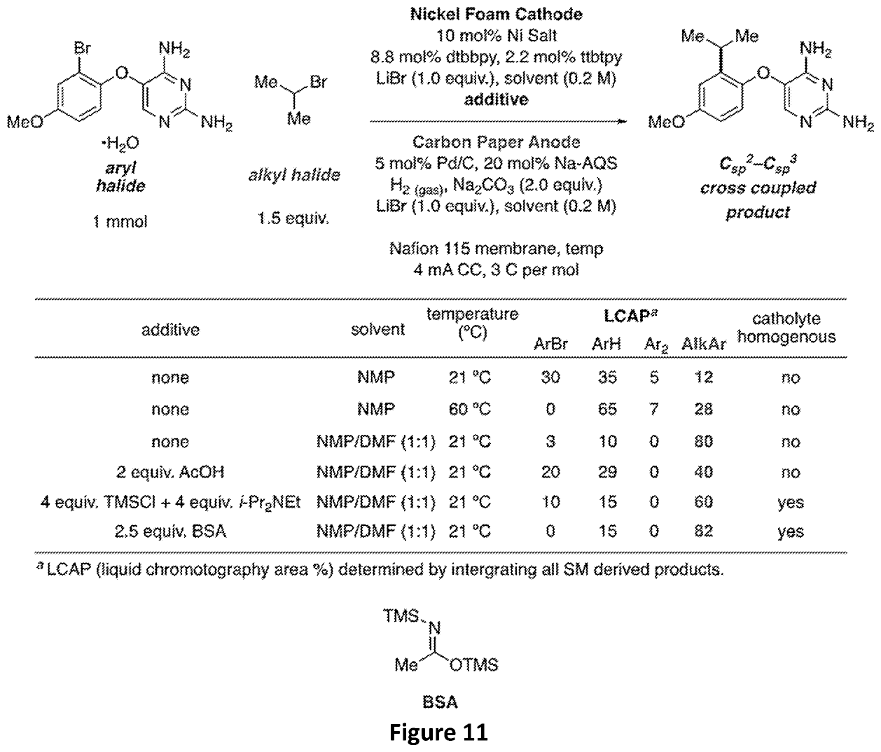

The aryl halide 5-(2-bromo-4-methoxyphenoxy)pyrimidine-2,4-diamine hydrate is insoluble in NMP below 100° C. When subjected to the optimized reaction conditions due to the low solubility of this substrate minimal formation of desired product occurs. Several mixed solvent systems and additives where evaluation (FIG. 11). Notably silylation of the substrate with either TMSCl and Hunig's base, or bis(trimethylsilyl)acetamide (BSA) caused the catholyte to become homogenous, an important feature for translation of this substrate to flow.

### Conversion Data Based on LCAP Data:

$$conversion = 100 - \frac{100 * S M}{( S M + pdt + ArH + Ar 2 )}$$

### IV. GENERAL PROCEDURE A FOR MEDIATED H₂ ANODE ENABLED CROSS ELECTROPHILE COUPLING IN A DIVIDED H-CELL

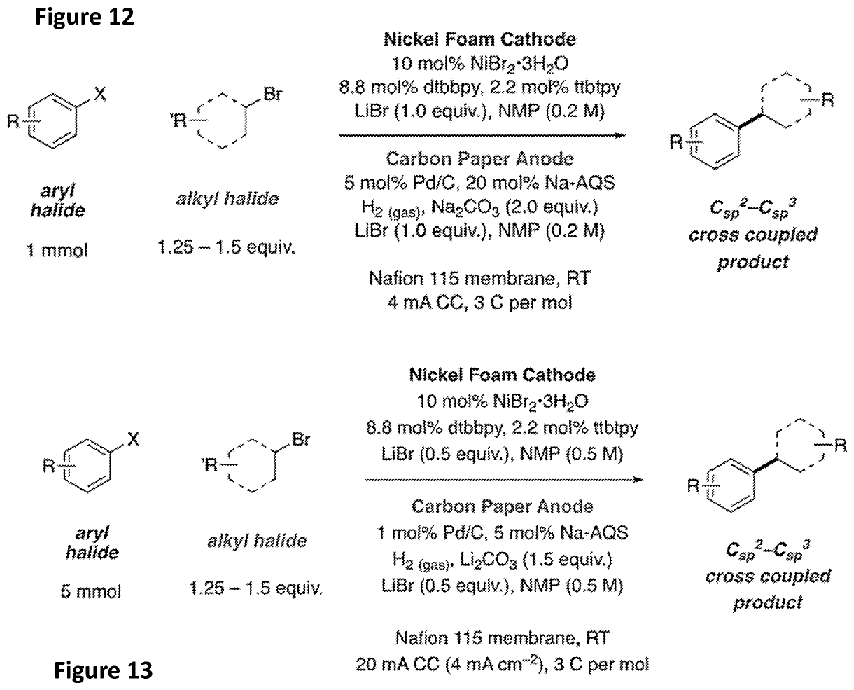

In a nitrogen filled glove box, to a 6-dram vial fitted with a cross shaped stir bar and a Teflon lined cap was added LiBr (347 mg, 4 mmol) and NMP (20 mL). The mixture was stirred in a glove box until complete dissolution of the LiBr. This vial was then removed from the glove box and placed under positive pressure on nitrogen on a Schlenk line. A 2.5×2.5 cm square of Nafion 115 was cut and placed in a small beaker. A 1 mL aliquot of the 0.2 M LiBr solution was removed under positive pressure of nitrogen and used to soak the Nafion membrane for 10 minutes. A divided H-cell was then assembled around the Nafion membrane using a Viton O-ring and ring clamp to secure the cell. Each chamber of the cell was fitted with a cross shaped stir bar. To the anodic chamber was added 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). A 5 cm×1×0.5 cm rectangle of RVC was cut using a razor blade and affixed to copper wire. A 14/20 rubber septum was punctured with a 14-gauge needle and the copper wire (with RVC electrode) was threaded through the rubber septum before removal of the needle. The RVC electrode was then placed in the anodic chamber roughly 5 mm above the stir bar and the 14/20 joint sealed with the rubber septum. See FIG. 12.

To the cathodic chamber was added NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %). At this stage if the aryl halide, or alkyl halide coupling partners were solid they were added to the cathodic compartment. A 2×4 cm rectangle of nickel foam was cut and affixed to copper wire (folded over the wire and crimped with a pair of plyers). A 14/20 rubber septum was punctured with a 14-gauge needle and the copper wire (with nickel foam electrode) was threaded through the rubber septum before removal of the needle. The nickel foam electrode was then placed in the cathodic chamber roughly 5 mm above the stir bar and the 14/20 joint sealed with the rubber septum. The head space of chamber of the H-cell was cleared via nitrogen flush for 10 minutes. The anodic compartment head space was then cleared with hydrogen gas for 10 minutes. 5 mL of the LiBr in NMP solution was withdrawn using a syringe and added to the cathodic compartment under nitrogen atmosphere. 7.5 mL of the LiBr in NMP solution was withdrawn using a syringe and added to the anodic compartment. The hydrogen purge needle was submerged under the surface of the solution and hydrogen flow rate adjusted to provide roughly one bubble per second, the anolyte and catholyte were stirred at 600 RPM until complete dissolution of the catholyte. At this stage if the aryl or alkyl halide electrophile where a liquid they were added to the cathodic compartment. The copper wires were attached to a BASi Epsilon or CH instruments potentiostat with the cathode identified as working electrode and the anode as counter and reference electrode. Constant current electrolysis was performed at −3-4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts, concentrated to dryness, and purified by silica gel chromatography.

### V. GENERAL PROCEDURE B FOR MEDIATED H₂ ANODE ENABLED CROSS ELECTROPHILE COUPLING IN A DIVIDED FLOW CELL

An Electrocell micro flow cell was used as the flow apparatus. The flow cell consisted of a Nafion 115 cation exchange membrane, a 5 cm² carbon paper anode distanced from the membrane with a PTFE screen, a 5 cm² commercial nickel foam cathode directly against the membrane, and two PTFE flow frames, with incompressible components separated by Viton gaskets.

The packed bed hydrogenation reactor (2.2 in length, 0.5 in OD) was made from a stainless-steel tube with 5 wt. % Pd/C (23 mg, 0.01 mmol, 1 mol %) retained using 1 inch of glass wool on each end. The anolyte solution, catholyte solution, and catalytic packed bed were prepared prior to operation. 2 24/40 rubber septa were punctured with a 14 gauge need and Teflon tubing (⅛ in ID and 3/16 in OD) were threaded though the septa. This Teflon tubing was fitted with HPLC frits. To a 100 mL 3 neck 24/40 round bottom flask with an oval stir bar was added AQS (78 mg, 0.25 mmol, 5 mol %), and Li₂CO₃ (554 mg, 7.5 mmol, 1.5 equiv.). 2 of the openings were fitted with the septa fitted with the frits, the final opening was fitted with an unmodified 24/40 rubber septa. The flask was then transferred into a nitrogen filled glove box and LiBr (1.042 g, 12 mmol) and NMP (60 mL) were added, the heterogenous mixture was stirred for 20 minutes. The flask was removed from the glove box and places under nitrogen atmosphere on a Schlenk line for 10 minutes. The Teflon tubing outlets were attached to Masterflex Pharmed tubing connected to the packed bed reactor (with HPLC pump) and flow cell (with peristaltic pump). H₂ was then vigorously bubbled through a 22 g needle into the solution to allow for hydrogen saturation of the solution. To a 8 dram vial fitted with a cross shaped stir bar was added NiBr₂·3H₂O (124 mg, 10 mol %, 0.5 mmol), 4,4′-di-tert-butyl-2,2′-bipyridine (118 mg, 8.8 mol %, 0.44 mmol) and 4,4′,4″-tri-tert-butyl-2,2′,2″-terpyridine (44.2 mg, 2.2 mol %, 0.11 mmol), at this stage if the alkyl or aryl electrophile were solid they were added to the vessel. The vial was then transferred to a nitrogen filled glove box, LiBr (208 g, 2.4 mmol, 0.48 equiv) and NMP (12 mL) were added. The catholyte containing vial was then stirred for 10 minutes. The sealed vial was then removed from the glove box and placed under nitrogen atmosphere on a Schlenk line. Masterflex Pharmed tubing connected to the cathodic side of the Microflow cell where fed into the cathodic reservoir via 16 gauge needle (with peristaltic pump). The system was left to equilibrate under nitrogen/hydrogen purge for 10 minutes. In one flow loop, an HPLC pump flowed the anolyte at 4 mL min⁻¹ through Teflon tubing and into the catalytic packed bed reactor. In the catalytic reactor, the AQS was reduced to anthrahydroquinone-2-sulfonate (AQS-H₂) and the anolyte then flowed back into the reservoir. After 45 minutes, a second flow loop used a peristaltic pump to cycle anolyte and catholyte through the electrochemical flow cell was started. In ideality the AQS-H₂ was oxidized on the carbon anode to form AQS and protons. The protons, separated from the proton exchange membrane by a PTFE screen, were carried back into the reservoir. Protons were prevented from accumulating by reaction with Li₂CO₃ in the anodic reservoir. On the cathode nickel catalyzed reductive coupling was expected to take place.

The flow cell was connected to a Biologic BP-300 potentiostat with the cathode selected as the working electrode and the anode as the counter electrode. A chronopotentiometry experiment was conducted with a constant current of −20 mA (4 mA·cm⁻²) until 3.5 F/mol were passed or until the cell potential dropped below −8 V. Upon completion of electrolysis the catholyte was collected and concentrated to dryness under high vacuum. The resultant residue was dissolved in EtOAc and passed through a small plug of silica to remove metal salts, concentrated to dryness, and purified by silica gel chromatography. See FIG. 13.

### Evaluation of Current Density on Selectivity of Ni-Catalyzed Cross Electrophile Coupling

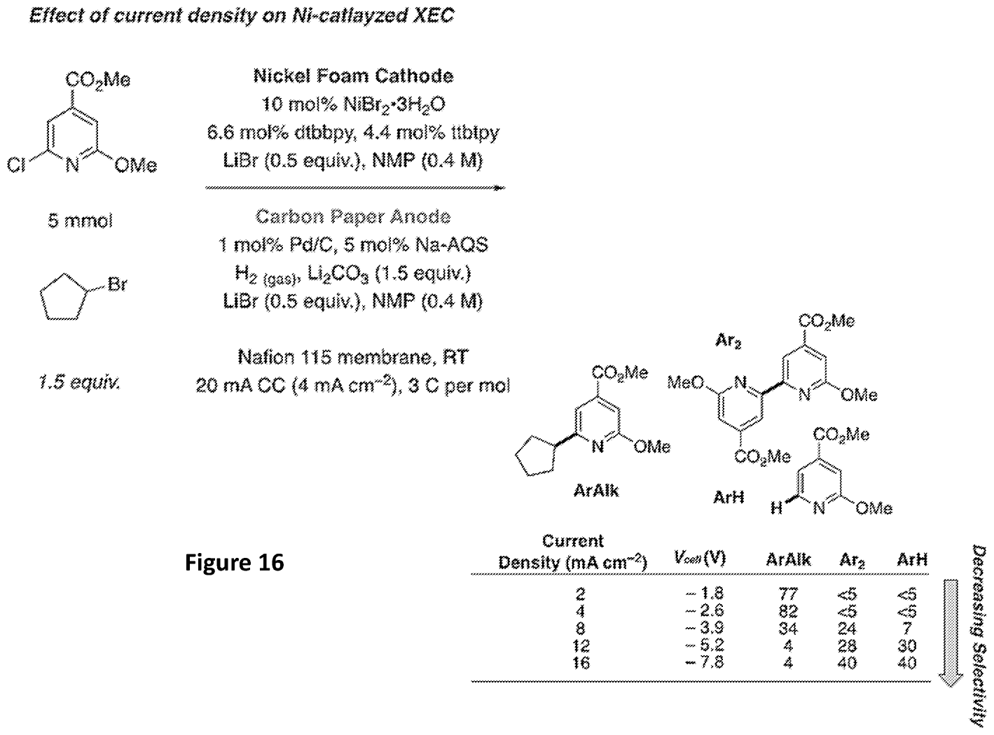

In order to demonstrate the mediated H₂ anode provided sufficient current density to enable Ni-catalyzed cross electrophile coupling, the cross coupling of methyl 2-chloro-6-methoxyisonicotinate and bromo cyclopentane where evaluated at multiple current densities in flow. The mediated H₂ can supply up to 20 mA·cm⁻² for extended periods of time (FIG. 7), as shown in FIG. 16 the Ni-catalyzed cross coupling shows diminished selectivity at current densities greater than 4 mA·cm⁻² demonstrating the mediated H₂ out performs the requirements of this system. We hypothesize the decreased selectivity observed at higher current densities to mismatched rates of oxidative addition and alkyl radical generation mediated by the 2 different ligated Ni species.

### VI. PROCEDURE FOR 100 GRAM SCALE MEDIATED H₂ ANODE ENABLED CROSS ELECTROPHILE COUPLING IN A DIVIDED FLOW CELL

An Electrocell Syn Cell electrochemical flow cell was used as the flow apparatus. The flow cell consisted of a Nafion 117 cation exchange membrane, a 0.16 m² carbon felt anode distanced from the membrane with a PTFE screen, a 0.16 m² commercial nickel foam cathode directly against the membrane, and two polypropylene flow frames, with incompressible components separated by PTFE gaskets.

The anodic solution was prepared in a nitrogen filled glovebox by weighing sodium 9,10-dioxo-9,10-dihydroanthracene-2-sulfonate into a 8 dram vial (7.69 g, 24.8 mmol, 5 mol %), LiBr into 2 8 dram vials (2×52 g vial=104 g, 1200 mmol, 2.4 equiv.). In a nitrogen filled glovebox lithium carbonate (55 g, 744 mol, 1.5 equiv) was weighed into a 500 mL Nalgene container. AQS and 1 vial of LiBr were added to a 1 L Nalgene bottles fitted with cross-shaped stir bar inside the glovebox. To a second 1 L Nalgene bottle fitted with a cross shaped stir bar was added the 2^{nd} vial of LiBr. To each of the Nalgene bottle was added approximately 750 ml of anhydrous NMP form 2×1 L bottles. Each Nalgene bottle was mixed using rotary stirring for 1 h. On the day of reaction, the bottles were then removed from the glovebox, the stir bar was removed, and the contents were charged to the anolyte reservoir (12 L round bottom flask). The bottle was rinsed with remaining NMP (approx. 250 ml NMP per bottle). 1 L dry NMP was used to rinse the two Nalgene bottles. Lithium carbonate was added into the anodic reservoir to avoid accumulation of generated protons in solution. To retain the lithium carbonate, it was packaged into seven pouches sealed with polypropylene zip ties (approx. 7.9 g per pouch) made of filter paper for a total of 55 g of Li carbonate charged. Finally, 3 L of NMP was added to the anolyte reservoir to bring the total volume to 6 L. The headspace was purged with N₂.

The cathodic solution was prepared in a nitrogen glovebox. To separate 8 dram vials was weighed NiBr₂glyme (1,2-dimethoxyethane)nickel dibromide (15.31 g, 49.6 mmol, 10 mol %)), 4,4′-di-tert-butyl-2,2′-bipyridine (8.79 g, 32.7 mmol, 6.6 mol %), 4,4′,4″-tri-tert-butyl-2,2′;6′,2″-terpyridine (8.76 g, 21.82 mmol, 4.4 mol %), and LiBr (52.1 g, 600 mmol, 1.2 equiv). These solids where transferred to a 1 L naglene bottle fitted with a cross shaped stir bar. 0.5 L of dry NMP was then added. Methyl 2-chloro-6-methoxyisonicotinate (100 g, 496 mmol) was weighed into a 500 mL Nalgene bottle and then transferred into a second 1 L Nalgene bottle containing a stir bar inside the glovebox. 0.5 L of dry NMP was added. The contents of each were mixed using rotary stirring overnight, after which they were partially dissolved but not entirely homogeneous. On the day of the flow experiment, stir bars were removed and both solutions were charged to the catholyte reservoir (a 10 L glass vessel), every bottle was rinsed with 2×0.5 L NMP. Then, a solution of cyclopentyl bromide (111 g, 80 mL, 744 mmol, 1.5 equiv) in 0.25 L of NMP was added. Finally, 0.75 L of dry NMP was added to the reservoir to achieve the desired 3 L volume. The headspace was swept with N₂ (5 psi pressure) and the catholyte was mixed with overhead stirring for over 1 hour (40 rpm), as a result a homogenous mixture was obtained and overhead stirring was ceased.

The packed bed hydrogenation reactor was composed of a Pd bed in a cylindrical stainless steel (SS) reactor. The SS reactor (½-inch OD, 9.5 in height) was packed with 3 g of dry Pd/C (Evonik 5 wt %, lot #PMPC150388, catalyst type PMPC SP1010D, 1.4 mmol, 0.3 mol %) and secured with two SS disk frits (304 SS, 40 mesh). The Pd column was rinsed with NMP without return line to anolyte reservoir to remove any loose particulates and then the column outlet was plumbed into the anolyte reservoir return loop. All NMP was removed from both the anolyte and catholyte reservoirs and then Karl-Fischer titrations were performed to assess water content prior to charging reagents. (KF anolyte=2 measurements: 4558 ppm, 4582 ppm; KF catholyte=2 measurements: 1486 ppm, 1455 ppm). Anolyte and catholyte solutions were then charged and brought to the desired final volume (6 L anolyte, 3 L catholyte).

Anolyte and catholyte solutions were pumped between the bed and the reservoir using a Masterflex Digital Gear Pump with pump head N25, while an N21 pump head was used for the hydrogenation reactor loop. Prior to electrolysis, the anolyte solution was pumped through the hydrogenation reactor at a rate of 0.5 L/min. in co-flow with H₂ gas, which was controlled by an Alicat mass flow controller at 70 SCCM (roughly 70 cm³ min⁻¹). The anolyte solution transitioned from yellow (fully oxidized) to green (partially or fully reduced). After pre-reduction of the anthraquinone species, the anolyte and catholyte were circulated through the cell at rates of 4.0 L/min. and a power supply was used to apply 6.4 A of constant current.

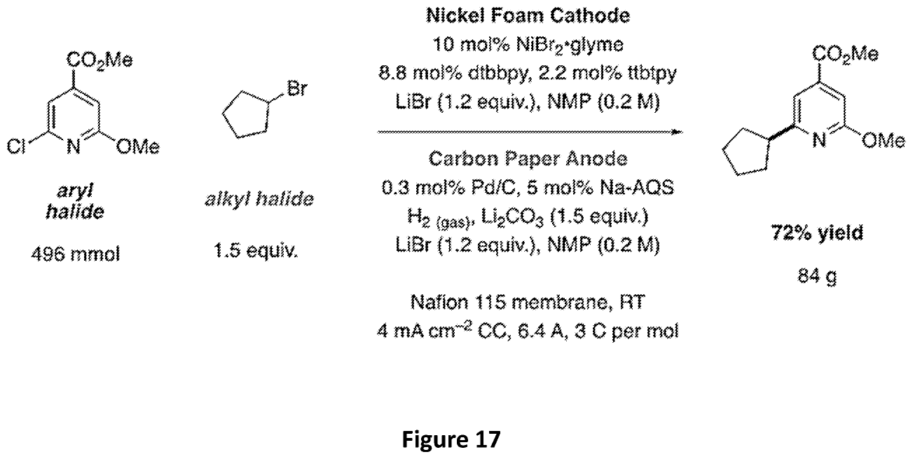

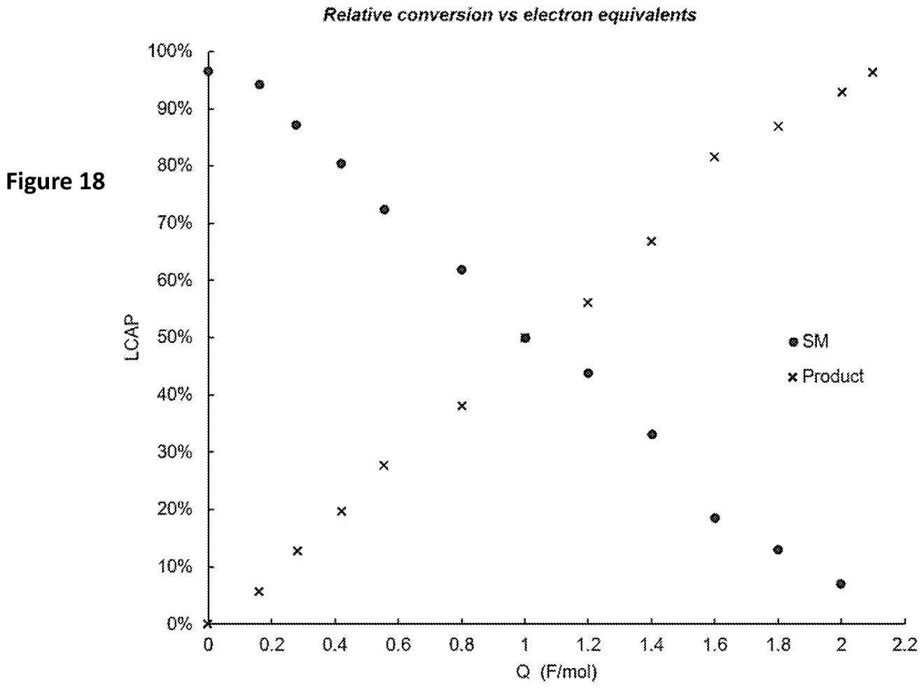

The reaction was monitored with bihourly analysis of cathodic aliquots by UPLC analysis (FIG. 18). When the reaction reached the cutoff cell voltage of 3 V after just under four hours, the experiment was stopped. The final product assay was conducted by Q-¹H-NMR in triplicate and showed 72% assay yield. See FIG. 17.

### Conversion Data Based on LCAP Data:

$$conversion = 100 - \frac{100 * S M}{( S M + Pdt )}$$

### VII. EXPERIMENTAL DATA FOR CROSS COUPLED PRODUCTS

### Aryl Halide Scope

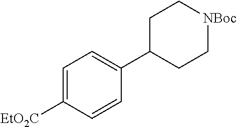 [SMILES: CCOC(=O)c1ccc(C2CCN(C(=O)OC(C)(C)C)CC2)cc1]

### tert-butyl 4-(4-(ethoxycarbonyl)phenyl)piperidine-1-carboxylate

Prepared via general procedure A from ethyl 4-bromobenzoate (229 mg, 163 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 80:20 gradient) to afford tert-butyl 4-(4-(ethoxycarbonyl)phenyl)piperidine-1-carboxylate as a colorless oil in 78% isolated yield (261 mg, 0.78 mmol)

¹H NMR (500 MHz, CDCl₃) δ 7.98 (d, J=8.3 Hz, 2H), 7.26 (d, J=8.3 Hz, 2H), 4.36 (q, J=7.1 Hz, 1H), 4.26 (s, 2H), 2.82 (t, J=13.2 Hz, 2H), 2.70 (tt, J=12.2, 3.6 Hz, 1H), 1.88-1.76 (m, 2H), 1.67-1.56 (m, 2H), 1.48 (s, 9H), 1.38 (t, J=7.1 Hz, 3H).

¹³C NMR (126 MHz, CDCl₃) δ 166.66, 154.96, 151.08, 130.00, 128.87, 126.93, 79.69, 60.98, 44.40, 42.97, 33.06, 28.63, 14.50.

Spectroscopic Data matches previous literature reports.
Truesdell, B. L.; Hamby, T. B.; Sevov, C. S. J. Am. Chem. Soc. 2020, 142, 5884-5893.

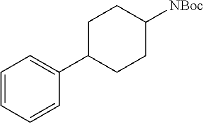

### tert-butyl 4-phenylpiperidine-1-carboxylate

Prepared via general procedure A from bromobenzene (157 mg, 105 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 90:10 gradient) to afford tert-butyl 4-phenylpiperidine-1-carboxylate as a colorless oil in 70% isolated yield (183 mg, 0.70 mmol)

¹H NMR (500 MHz, CDCl₃) δ 7.31 (dd, J=8.5, 6.9 Hz, 1H), 7.23-7.17 (m, 2H), 4.24 (bs, 2H), 2.80 (s, 2H), 2.64 (tt, J=12.2, 3.6 Hz, 1H), 1.82 (d, J=13.2 Hz, 2H), 1.62 (qd, J=12.0, 5.2 Hz, 2H), 1.46 (s, 9H).

¹³C NMR (126 MHz, CDCl₃) δ 154.65, 145.82, 128.51, 126.78, 126.34, 79.82, 44.20, 42.74, 33.20, 28.42.

Spectroscopic data matches previous literature reports.
Barre, B.; Gonnard, L.; Campagne, R.; Reymond, S.; Ciapetti, P.; Brellier, M.; Guérinot, A.; Cossy, J. Org. Lett. 2014, 16, 6160-6163.

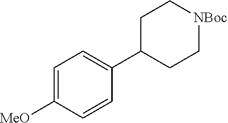 [SMILES: COc1ccc(C2CCN(C(=O)OC(C)(C)C)CC2)cc1]

### tert-butyl 4-(4-methoxyphenyl)piperidine-1-carboxylate

Prepared via general procedure A from 4-bromoanisole (187 mg, 127 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 90:10 gradient) to afford tert-butyl 4-(4-methoxyphenyl)piperidine-1-carboxylate as a colorless oil in 84% isolated yield (245 mg, 0.84 mmol).

¹H NMR (500 MHz, CDCl₃) δ 7.12 (d, J=8.7 Hz, 2H), 6.85 (d, J=8.6 Hz, 2H), 4.30-4.16 (m, 2H), 3.08 (s, 3H), 2.79 (s, 2H), 2.59 (tt, J=12.2, 3.6 Hz, 1H), 1.87-1.72 (m, 2H), 1.65-1.52 (m, 2H), 1.48 (s, 9H).

¹³C NMR (126 MHz, CDCl₃) δ 158.20, 155.03, 138.17, 127.77, 114.02, 79.53, 55.40, 44.58, 41.99, 33.57, 28.64.

Spectroscopic data matches previous literature reports.
Molander, G. A.; Traister, K. M.; O'Neill, B. T. J. Org. Chem. 2014, 79, 5771-5780.

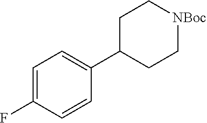 [SMILES: CC(C)(C)OC(=O)N1CCC(c2ccc(F)cc2)CC1]

### tert-butyl 4-(4-fluorophenyl)piperidine-1-carboxylate

Prepared via general procedure A from 1-bromo-4-fluorobenzene (175 mg, 117 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 90:10 gradient) to afford tert-butyl 4-(4-fluorophenyl)piperidine-1-carboxylate as a colorless oil in 72% isolated yield (201 mg, 0.72 mmol).

¹H NMR (500 MHz, CDCl₃) δ 7.18-7.12 (m, 2H), 7.02-6.95 (m, 2H), 4.24 (bs, 2H), 2.79 (bs, 2H), 2.62 (tt, J=12.2, 3.6 Hz, 1H), 1.80 (dt, J=13.7, 2.6 Hz, 2H), 1.63-1.52 (m, 2H), 1.48 (s, 9H).

¹³C NMR (126 MHz, CDCl₃) δ 161.55 (d, J=244.0 Hz), 154.98, 141.61 (d, J=3.2 Hz), 128.23 (d, J=7.8 Hz), 115.36 (d, J=21.2 Hz), 79.62, 44.49, 42.15, 33.50, 28.63.

¹⁹F NMR (377 MHz, CDCl₃) δ −117.0 (ddd, J=14.2, 8.8, 5.3 Hz).

Spectroscopic data matches previous literature reports.
Barre, B.; Gonnard, L.; Campagne, R.; Reymond, S.; Ciapetti, P.; Brellier, M.; Guérinot, A.; Cossy, J. Org. Lett. 2014, 16, 6160-6163.

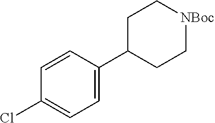 [SMILES: CC(C)(C)OC(=O)N1CCC(c2ccc(Cl)cc2)CC1]

### tert-butyl 4-(4-chlorophenyl)piperidine-1-carboxylate

Prepared via general procedure A from 1-bromo-4-chlorobenzene (191 mg, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 90:10 gradient) to afford tert-butyl 4-(4-chlorophenyl)piperidine-1-carboxylate as a colorless oil in 80% isolated yield (236 mg, 0.80 mmol).

¹H NMR (500 MHz, CDCl₃) δ 7.27 (d, J=8.2 Hz, 2H), 7.13 (d, J=8.5 Hz, 2H), 4.24 (bs, 2H), 2.79 (bs, 2H), 2.62 (tt, J=12.2, 3.6 Hz, 1H), 1.84-1.74 (m, 2H), 1.67-1.52 (m, 2H), 1.48 (s, 9H).

¹³C NMR (126 MHz, CDCl₃) δ 154.83, 144.24, 131.98, 128.62, 128.13, 79.52, 44.27, 42.16, 33.15, 28.49.

Spectroscopic data matches previous literature reports.
Wanatabe, E.; Yiding, C.; May, O; Ley, S. V. Chem. Eur. Joc. 2020, 26, 186-191.

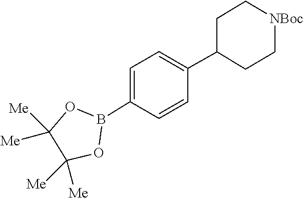 [SMILES: CC(C)(C)OC(=O)N1CCC(c2ccc(B3OC(C)(C)C(C)(C)O3)cc2)CC1]

### tert-butyl 4-(4-(4,4,5,5-tetramethyl-1,3,2-dioxaborolan-2-yl)phenyl)piperidine-1-carboxylate

Prepared via general procedure A from 1 2-(4-bromophenyl)-4,4,5,5-tetramethyl-1,3,2-dioxaborolane (283 mg, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 70:30 gradient) to afford tert-butyl 4-(4-(4,4,5,5-tetramethyl-1,3,2-dioxaborolan-2-yl)phenyl)piperidine-1-carboxylate as colorless crystalline solid in 70% isolated yield (272 mg, 0.7 mmol).

¹H NMR (500 MHz, CDCl₃) δ 7.76 (d, J=8.0 Hz, 2H), 7.22 (d, J=7.9 Hz, 2H), 4.24 (s, 2H), 2.79 (t, 1H), 2.65 (tt, J=8.5, 3.6 Hz, 1H), 1.81 (d, J=13.0 Hz, 2H), 1.70-1.55 (m, 2H), 1.48 (s, 6H), 1.33 (s, 9H).

¹³C NMR (126 MHz, CDCl₃) δ 154.99, 149.24, 135.23, 126.41, 83.84, 79.57, 44.49, 43.11, 33.15, 28.64, 24.99.

HRMS (ESI-MS) calcd for NaC₂₂H₃₄BNO₄⁺ [M+Na]⁺ 410.2473—found—410.2471.

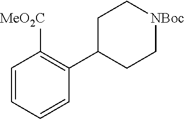 [SMILES: COC(=O)c1ccccc1C1CCN(C(=O)OC(C)(C)C)CC1]

### tert-butyl 4-(2-(methoxycarbonyl)phenyl)piperidine-1-carboxylate

Prepared via general procedure A from methyl 2-bromobenzoate (215 mg, 140 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 90:10 gradient) to afford tert-butyl 4-(2-(methoxycarbonyl)phenyl)piperidine-1-carboxylate as colorless crystalline solid in 48% isolated yield (153 mg, 0.48 mmol).

¹H NMR (500 MHz, CDCl₃) δ 7.80 (dd, J=7.8, 1.5 Hz, 1H), 7.46 (td, J=7.7, 1.5 Hz, 1H), 7.35 (dd, J=8.1, 1.2 Hz, 1H), 7.25 (td, J=7.6, 1.3 Hz, 1H), 4.24 (s, 2H), 3.90 (s, 3H), 3.54 (ddd, J=12.1, 8.7, 3.4 Hz, 1H), 2.84 (s, 2H), 1.83 (dt, J=12.7, 2.6 Hz, 2H), 1.67-1.55 (m, 3H), 1.48 (s, 9H).

¹³C NMR (126 MHz, CDCl₃) δ (126 MHz, CDCl₃) δ 168.55, 155.04, 146.97, 132.16, 130.45, 129.85, 126.99, 126.09, 79.53, 52.20, 44.74, 38.59, 33.28, 28.65.

Spectroscopic data matches previous literature reports.
Corley, E. G.; Conrad, K.; Murry, J. A.; Savarin, C.; Holko, J.; Boice, G.; J. Org. Chem. 2004, 69, 5120-5123.

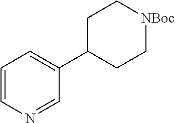 [SMILES: CC(C)(C)OC(=O)N1CCC(c2cccnc2)CC1]

### tert-butyl 4-(pyridin-3-yl)piperidine-1-carboxylate

Prepared via general procedure A from 3-bromopyridine (158 mg, 96 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 50:50 gradient) to afford tert-butyl 4-(pyridin-3-yl)piperidine-1-carboxylate as colorless oil in 82% isolated yield (216 mg, 0.82 mmol).

¹H NMR (500 MHz, CDCl₃) δ 8.47 (dt, J=10.7, 3.3 Hz, 2H), 7.50 (dt, J=7.2, 2.2 Hz, 1H), 7.23 (ddd, J=7.8, 4.5, 2.3 Hz, 1H), 4.26 (bs, 2H), 2.93-2.75 (m, 2H), 2.68 (td, J=12.2, 3.3 Hz, 1H), 1.89-1.77 (m, 2H), 1.62 (dtd, J=16.1, 12.4, 11.1, 4.0 Hz, 2H), 1.48 (s, 9H).

¹³C NMR (126 MHz, CDCl₃) δ 154.93, 149.05, 148.11, 140.93, 134.14, 123.61, 79.76, 43.10, 40.39, 33.01, 28.62.

Spectroscopic data matches previous literature reports.
Barre, B.; Gonnard, L.; Campagne, R.; Reymond, S.; Ciapetti, P.; Brellier, M.; Guérinot, A.; Cossy, J. Org. Lett. 2014, 16, 6160-6163.

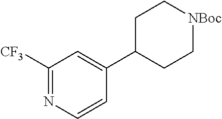 [SMILES: CC(C)(C)OC(=O)N1CCC(c2ccnc(C(F)(F)F)c2)CC1]

### tert-butyl 4-(2-(trifluoromethyl)pyridin-4-yl)piperidine-1-carboxylate

### Pentane EtOAc (100:0 to 80:20 Gradient)

Prepared via general procedure A from 4-chloro-2-trifluoromethylpyridine (182 mg, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 80:20 gradient) to afford tert-butyl 4-(2-(trifluoromethyl)pyridin-4-yl)piperidine-1-carboxylate as colorless oil in 72% isolated yield (238 mg, 0.72 mmol).

¹H NMR (500 MHz, CDCl₃) δ 8.63 (d, J=5.0 Hz, 1H), 7.52 (s, 1H), 7.32 (d, J=5.1 Hz, 1H), 4.29 (bs, 2H), 3.01-2.65 (m, 3H), 1.86 (d, J=13.0 Hz, 2H), 1.63 (qd, J=10.7, 3.3 Hz, 2H), 1.48 (s, 9H).

¹³C NMR (126 MHz, CDCl₃) δ 156.52, 154.80, 150.35, 148.71 (q, J=34.2 Hz), 124.92, 121.73 (q, J=274.2 Hz), 119.17 (q, J=2.8 Hz), 79.96, 44.02, 42.27, 32.33, 28.58.

¹⁹F NMR (377 MHz MHz, CDCl₃) δ −67.8.

Spectroscopic data matches previous literature reports.
Jie, W.; Qin, T.; Chen, T.-G.; Wimmer, J.; Edwards, J. T.; Cornella, J.; Vokits, B.; Shaw, S. A.; Baran, P. S. Angew. Chem. Int. Ed. 2016, 55, 9676-9679.

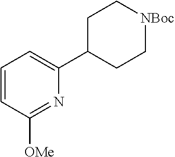 [SMILES: COc1cccc(C2CCN(C(=O)OC(C)(C)C)CC2)n1]

### tert-butyl 4-(6-methoxypyridin-2-yl)piperidine-1-carboxylate

Prepared via general procedure A from 2-chloro-6-methoxypyridine (144 mg, 119 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (17.7 mg, 0.066 mmol, 6.6 mol %), and ttbtpy (17.6 mg, 0.044 mmol, 4.4 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 70:30 gradient) to afford tert-butyl 4-(6-methoxypyridin-2-yl)piperidine-1-carboxylate as colorless oil in 60% isolated yield (174 mg, 0.6 mmol).

¹H NMR (500 MHz, CDCl₃) δ 7.48 (dd, J=8.2, 7.2 Hz, 1H), 6.69 (d, J=7.2 Hz, 1H), 6.55 (dd, J=8.2, 0.8 Hz, 1H), 4.22 (s, 2H), 3.91 (s, 2H), 2.83 (t, J=12.4 Hz, 2H), 2.72 (tt, J=11.8, 3.7 Hz, 1H), 1.95-1.84 (m, 2H), 1.73 (qd, J=12.5, 4.3 Hz, 2H), 1.48 (s, 9H).

¹³C NMR (126 MHz, CDCl₃) δ 163.71, 162.41, 155.08, 138.98, 113.47, 108.08, 93.07, 79.48, 53.26, 44.15, 44.03, 31.58, 28.63.

HRMS (ESI-MS) calcd for NaC₁₆H₂₄N₂O₃⁺ [M+Na]⁺ 315.1679—found—

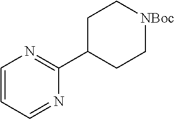 [SMILES: CC(C)(C)OC(=O)N1CCC(c2ncccn2)CC1]

### tert-butyl 4-(pyrimidin-2-yl)piperidine-1-carboxylate

Prepared via general procedure A from 2-chloropyrimidine (115 mg, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 70:30 gradient) to afford tert-butyl 4-(pyrimidin-2-yl)piperidine-1-carboxylate as colorless oil in 50% isolated yield (133 mg, 0.5 mmol).

¹H NMR (500 MHz, CDCl₃): δ 8.71 (d, J=4.9. Hz, 2H), 7.17 (app t, J=4.8 Hz, 1H), 4.23 (s, 2H), 3.03 (m, 1H), 2.86 (m, 2H), 1.99 (d, J=13 Hz, 2H), 1.82 (dq, J=4.5, 12.5 Hz, 2H), 1.50 (s, 9H).

HRMS (ESI-MS) calcd for C₁₄H₂₂N₃O₂⁺[M+H]⁺ 264.1707—found—

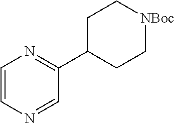 [SMILES: CC(C)(C)OC(=O)N1CCC(c2cnccn2)CC1]

Prepared via general procedure A from 2-chloropyrazine (115 mg, 90 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 70:30 gradient) to afford tert-butyl 4-(pyrazin-2-yl)piperidine-1-carboxylate as colorless oil in 52% isolated yield (137 mg, 0.52 mmol).

¹H NMR (500 MHz, CDCl₃) δ 8.50 (dd, J=2.5, 1.5 Hz, 1H), 8.48 (d, J=1.5 Hz, 1H), 8.43 (d, J=2.5 Hz, 1H), 4.27 (s, 2H), 2.93-2.78 (m, 3H), 1.91 (d, J=13.0 Hz, 2H), 1.77 (qd, J=12.8, 4.4 Hz, 2H), 1.48 (s, 9H).

¹³C NMR (126 MHz, CDCl₃) δ 159.84, 154.88, 144.23, 143.52, 142.87, 79.73, 44.17, 42.27, 31.37, 28.62.

HRMS (ESI-MS) calcd for C₁₄H₂₂N₃O₂⁺ [M+H]⁺ 264.1707—found—264.1703.

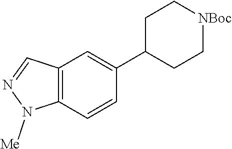 [SMILES: Cn1ncc2cc(C3CCN(C(=O)OC(C)(C)C)CC3)ccc21]

### tert-butyl 4-(1-methyl-1H-indazol-5-yl)piperidine-1-carboxylate

Prepared via general procedure A from 5-bromo-1-methyl-1H-indazole (211 mg, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 70:30 gradient) to afford tert-butyl 4-(1-methyl-1H-indazol-5-yl)piperidine-1-carboxylate as colorless oil in 75% isolated yield (237 mg, 0.75 mmol).

¹H NMR (500 MHz, CDCl₃) δ 7.92 (d, J=0.9 Hz, 1H), 7.52 (s, 1H), 7.34 (d, J=8.7 Hz, 1H), 7.26 (dd, J=8.6, 1.6 Hz, 1H), 4.27 (s, 2H), 4.05 (s, 3H), 2.83 (t, J=12.9 Hz, 2H), 2.75 (tt, J=12.2, 3.6 Hz, 1H), 1.93-1.78 (m, 2H), 1.67 (qd, J=12.6, 4.3 Hz, 3H), 1.49 (s, 9H).

¹³C NMR (126 MHz, CDCl₃) δ 155.02, 139.16, 138.28, 132.55, 126.29, 124.41, 118.08, 109.10, 79.58, 44.60, 42.73, 35.67, 33.78, 28.64, 28.61.

HRMS (ESI-MS) calcd for C₁₈H₂₆N₃O₂⁺ [M+H]⁺ 316.2020—found—316.2015.

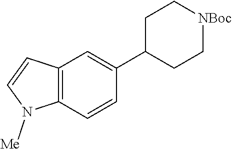 [SMILES: Cn1ccc2cc(C3CCN(C(=O)OC(C)(C)C)CC3)ccc21]

### tert-butyl 4-(1-methyl-1H-indol-5-yl)piperidine-1-carboxylate

Prepared via general procedure A from 5-bromo-1-methyl-1H-indole (210 mg, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 80:20 gradient) to afford tert-butyl 4-(1-methyl-1H-indol-5-yl)piperidine-1-carboxylate as colorless oil in 68% isolated yield (214 mg, 0.68 mmol).

¹H NMR (500 MHz, CDCl₃) δ 7.43 (d, J=1.7 Hz, 1H), 7.24 (s, 1H), 7.07 (dd, J=8.4, 1.7 Hz, 1H), 7.02 (d, J=3.1 Hz, 1H), 6.43 (dd, J=3.1, 0.9 Hz, 1H), 4.25 (s, 2H), 2.81 (s, 2H), 2.72 (tt, J=12.2, 3.7 Hz, 1H), 1.85 (d, J=13.1 Hz, 2H), 1.68 (qt, J=13.3, 6.8 Hz, 2H), 1.48 (s, 9H).

¹³C NMR (126 MHz, CDCl₃) δ 155.09, 137.06, 135.73, 129.23, 128.76, 121.06, 118.45, 109.27, 92.93, 79.45, 44.71, 42.98, 34.06, 32.97, 28.66.

Spectroscopic data matches previous literature reports.
Jie, W.; Qin, T.; Chen, T.-G.; Wimmer, J.; Edwards, J. T.; Cornella, J.; Vokits, B.; Shaw, S. A.; Baran, P. S. Angew. Chem. Int. Ed. 2016, 55, 9676-9679.

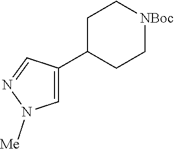 [SMILES: Cn1cc(C2CCN(C(=O)OC(C)(C)C)CC2)cn1]

### tert-butyl 4-(1-methyl-1H-pyrazol-4-yl)piperidine-1-carboxylate

Prepared via general procedure A from 4-bromo-1-methyl-1H-pyrazole (161 mg, 103 mL, 1.0 mmol, 1.0 equiv.) and tert-butyl 4-bromopiperidine-1-carboxylate (330 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 60:40 gradient) to afford tert-butyl 4-(1-methyl-1H-pyrazol-4-yl)piperidine-1-carboxylate as colorless oil in 70% isolated yield (186 mg, 0.70 mmol).

¹H NMR (500 MHz, CDCl₃) δ 7.32 (s, 1H), 7.13 (s, 1H), 4.12 (s, 6H), 3.85 (s, 3H), 2.80 (t, J=13.2 Hz, 3H), 2.62 (ddt, J=11.7, 7.9, 3.8 Hz, 3H), 1.92-1.81 (m, 3H), 1.64 (d, J=12.9 Hz, 2H), 1.46 (s, 11H).

¹³C NMR (126 MHz, CDCl₃) δ 154.98, 137.26, 127.03, 126.59, 79.41, 44.34, 41.20, 33.49, 32.48, 29.84, 28.61.

HRMS (ESI-MS) calcd for C₁₄H₂₃N₃O₂⁺ [M+H]⁺ 266.1863—found—266.1858.

### Alkyl Halide Scope

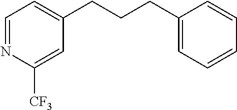 [SMILES: FC(F)(F)c1cc(CCCc2ccccc2)ccn1]

### 4-(3-phenylpropyl)-2-(trifluoromethyl)pyridine

Prepared via general procedure A from 4-chloro-2-trifluoromethylpyridine (182 mg, 1.0 mmol, 1.0 equiv.) and 1-bromo-3-phenylpropane (297 mg, 227 mL, 1.5 mmol, 1.5 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 90:10 gradient) to afford 4-(3-phenylpropyl)-2-(trifluoromethyl)pyridine as colorless oil in 82% isolated yield (220 mg, 0.82 mmol).

¹H NMR (500 MHz, CDCl₃) δ 8.60 (d, J=5.0 Hz, 1H), 7.50 (d, J=1.6 Hz, 1H), 7.33-7.28 (m, 3H), 7.24-7.15 (m, 3H), 2.77-2.66 (m, 4H), 2.01 (tt, J=8.9, 6.9 Hz, 2H).

¹³C NMR (126 MHz, CDCl₃) δ 153.39, 150.01, 148.44 (q, J=34.1 Hz), 141.27, 128.65, 128.53, 126.55, 126.30, 121.5 (q, J=275.0 Hz), 120.70 (q, J=2.8 Hz), 35.36, 34.78, 31.73.

¹⁹F NMR (377 MHz MHz, CDCl₃) δ −67.97.

HRMS (ESI-MS) calcd for C₁₅H₁₅F₃N⁺ [M+H]⁺ 266.1151—found—266.1148.

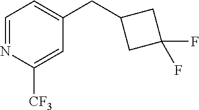 [SMILES: FC1(F)CC(Cc2ccnc(C(F)(F)F)c2)C1]

### 4-((3,3-difluorocyclobutyl)methyl)-2-(trifluoromethyl)pyridine

Prepared via general procedure A from 4-chloro-2-trifluoromethylpyridine (182 mg, 1.0 mmol, 1.0 equiv.) and 3-(bromomethyl)-1,1-difluorocyclobutane (231 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 85:15 gradient) to afford 4-((3,3-difluorocyclobutyl)methyl)-2-(trifluoromethyl)pyridine as colorless oil in 60% isolated yield (151 mg, 0.60 mmol).

¹H NMR (500 MHz, CDCl₃) δ 8.63 (dd, J=5.2, 2.4 Hz, 1H), 7.47 (s, 1H), 7.27 (dd, J=5.1, 1.7 Hz, 1H), 2.91 (d, J=7.9 Hz, 2H), 2.78-2.64 (m, 2H), 2.54-2.42 (m, 1H), 2.37-2.20 (m, 2H).

¹³C NMR (126 MHz, CDCl₃) δ 150.73, 150.32, 148.75 (q, J=34.3 Hz), 126.44, 120.58 (q, J=2.7 Hz), 119.70 (dd, J=282.6, 275.5 Hz), 40.94-40.27 (m), 23.54 (dd, J=12.0, 7.1 Hz).

¹⁹F NMR (377 MHz, CDCl₃) δ −68.05, −83.29 (ddtd, J=190.3, 17.0, 8.6, 4.3 Hz), −94.40 (dqd, J=194.5, 14.2, 2.6 Hz).

HRMS (ESI-MS) calcd for C₁₁H₁₁F₅N⁺ [M+H]⁺ 252.0806—found—252.0802.

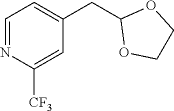 [SMILES: FC(F)(F)c1cc(CC2OCCO2)ccn1]

### 4-((1,3-dioxolan-2-yl)methyl)-2-(trifluoromethyl)pyridine

Prepared via general procedure A from 4-chloro-2-trifluoromethylpyridine (182 mg, 1.0 mmol, 1.0 equiv.) and 2-(bromomethyl)-1,3-dioxolane (209 mg, 130 mL, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 85:15 gradient) to afford 4-((1,3-dioxolan-2-yl)methyl)-2-(trifluoromethyl)pyridine as colorless oil in 72% isolated yield (168 mg, 0.72 mmol).

¹H NMR (400 MHz, CDCl₃) δ 8.62 (d, J=4.9 Hz, 1H), 7.61 (s, 1H), 7.41 (dd, J=5.0, 1.6 Hz, 1H), 5.12 (t, J=4.3 Hz, 1H), 3.92-3.82 (m, H), 3.05 (d, J=4.3 Hz, 2H).

¹³C NMR (126 MHz, CDCl₃) δ 149.85, 148.26 (q, J=34.3 Hz), 147.19, 128.07, 122.61 (q, J=272.0 Hz), 122.16 (q, J=2.8 Hz), 102.97, 65.31, 40.02.

¹⁹F NMR (377 MHz MHz, CDCl₃) δ −68.1.

HRMS (ESI-MS) calcd for C₁₀HnF₃NO₂⁺[M+H]⁺ 234.0736—found—234.0734.

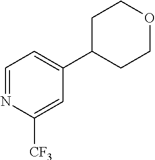 [SMILES: FC(F)(F)c1cc(C2CCOCC2)ccn1]

### 4-(tetrahydro-2H-pyran-4-yl)-2-(trifluoromethyl)pyridine

Prepared via general procedure A from 4-chloro-2-trifluoromethylpyridine (182 mg, 1.0 mmol, 1.0 equiv.) and 4-bromotetrahydropyran (206 mg, 141 mL, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 80:20 gradient) to afford 4-(tetrahydro-2H-pyran-4-yl)-2-(trifluoromethyl)pyridine as colorless oil in 75% isolated yield (173 mg, 0.75 mmol).

¹H NMR (500 MHz, CDCl₃) δ 8.65 (d, J=5.1 Hz, 1H), 7.54 (d, J=1.6 Hz, 1H), 7.34 (dd, J=5.0, 1.6 Hz, 1H), 4.11 (dt, J=11.6, 3.4 Hz, 2H), 3.64-3.46 (m, 2H), 2.91-2.81 (m, 1H), 1.90-1.77 (m, 4H).

¹³C NMR (126 MHz, CDCl₃) (377 MHz MHz, CDCl₃) δ 156.51, 150.38, 148.74 (q, J=34.3 Hz), 120.29 (q, J=274.2 Hz), δ 119.15 (q, J=2.8 Hz), 67.95, 41.12, 32.94.

¹⁹F NMR (377 MHz MHz, CDCl₃) δ −67.9

HRMS (ESI-MS) calcd for C₁₁H₁₃F₃NO⁺ [M+H]⁺ 232.0944—found—232.0940.

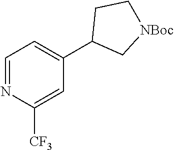 [SMILES: CC(C)(C)OC(=O)N1CCC(c2ccnc(C(F)(F)F)c2)C1]

### tert-butyl 3-(2-(trifluoromethyl)pyridin-4-yl)pyrrolidine-1-carboxylate

Prepared via general procedure A from 4-chloro-2-trifluoromethylpyridine (182 mg, 1.0 mmol, 1.0 equiv.) and tert-Butyl 3-bromopyrrolidine-1-carboxylate (313 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 70:30 gradient) to tert-butyl 3-(2-(trifluoromethyl)pyridin-4-yl)pyrrolidine-1-carboxylate as colorless oil in 85% isolated yield (269 mg, 0.85 mmol).

¹H NMR (500 MHz, CDCl₃) δ 8.65 (t, J=3.9 Hz, 1H), 7.53 (t, J=2.2 Hz, 1H), 7.37-7.31 (m, 1H), 3.91-3.77 (m, 1H), 3.72-3.26 (m, 2H), 2.48-2.28 (m, 2H), 2.15-1.92 (m, 2H), 1.49-1.40 (m, 9H).

¹³C NMR (126 MHz, CDCl₃) δ 175.19, 154.42 (q, J=13.3 Hz), 152.91 (q, J=16.4 Hz), 150.42, 148.82 (q, J=34.4 Hz), 125.10, 121.63 (q, J=274.3 Hz), 119.32 (q, J=2.8 Hz), 79.90, 51.65, 51.00, 45.65, 45.43, 43.68, 42.72, 32.88, 31.94, 28.61.

¹⁹F NMR (377 MHz MHz, CDCl₃) δ −68.0.

HRMS (ESI-MS) calcd for C₁₅H₂₀F₃N₂O₂⁺ [M+H]⁺ 317.1471—found—317.1466.

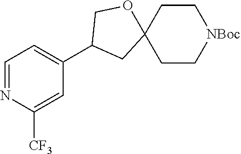 [SMILES: CC(C)(C)OC(=O)N1CCC2(CC1)CC(c1ccnc(C(F)(F)F)c1)CO2]

### tert-butyl 3-(2-(trifluoromethyl)pyridin-4-yl)-1-oxa-8-azaspiro[4.5]decane-8-carboxylate

Prepared via general procedure A from 4-chloro-2-trifluoromethylpyridine (182 mg, 1.0 mmol, 1.0 equiv.) and tert-butyl (±)-3-bromo-1-oxa-8-azaspiro[4.5]decane-8-carboxylate (400 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 70:30 gradient) to afford tert-butyl 3-(2-(trifluoromethyl)pyridin-4-yl)-1-oxa-8-azaspiro[4.5]decane-8-carboxylate as colorless wax in 80% isolated yield (309 mg, 0.80 mmol).

¹H NMR (500 MHz, CDCl₃) δ 8.64 (d, J=5.0 Hz, 1H), 7.54 (d, 1H), 7.36 (dd, J=5.0, 1.7 Hz, 1H), 4.25 (dd, J=9.0, 7.3 Hz, 1H), 3.84 (dd, J=9.0, 8.0 Hz, 1H), 3.66 (d, J=10.4 Hz, 2H), 3.57 (p, J=8.2 Hz, 1H), 3.32 (tdd, J=13.7, 9.9, 3.7 Hz, 2H), 2.32 (dd, J=12.7, 8.4 Hz, 1H), 1.79 (dd, J=12.7, 9.3 Hz, 1H), 1.76-1.66 (m, 3H), 1.57 (ddd, J=13.7, 10.2, 4.3 Hz, 1H), 1.45 (s, 9H).

¹³C NMR (126 MHz, CDCl₃) δ 154.90, 153.51, 150.39, 148.80 (q, J=34.3 Hz), 125.26, 121.63 (d, J=274.3 Hz), 119.49 (q, J=2.8 Hz), 81.36, 79.67, 72.14, 45.22, 44.33, 41.11, 37.05, 36.21, 28.57.

¹⁹F NMR (377 MHz MHz, CDCl₃) δ −68.0.

HRMS (ESI-MS) calcd for C₁₉H₂₆F₃N₂O₃⁺ [M+H]⁺ 387.1890—found—387.1883.

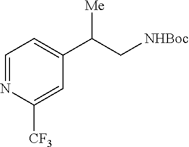 [SMILES: CC(CNC(=O)OC(C)(C)C)c1ccnc(C(F)(F)F)c1]

### tert-butyl (2-(2-(trifluoromethyl)pyridin-4-yl)propyl)carbamate

Prepared via general procedure A from 4-chloro-2-trifluoromethylpyridine (182 mg, 1.0 mmol, 1.0 equiv.) and tert-butyl (±)-(2-bromopropyl)carbamate (298 mg, 1.25 mmol, 1.25 equiv.), with NiBr₂·3H₂O (27.3 mg, 0.1 mmol, 10 mol %), dtbbpy (23.6 mg, 0.088 mmol, 8.8 mol %), and ttbtpy (8.8 mg, 0.022 mmol, 2.2 mol %) as catalyst in the cathodic chamber. The anodic chamber contained 5% b/w palladium on carbon (42 mg, 0.02 mmol, 2 mol %), sodium anthraquinone monosulfate (62 mg, 0.2 mmol, 20 mol %), and Na₂CO₃ (210 mg, 2 mmol, 2 equiv.). 0.2 M LiBr solution was added to each chamber, 5 mL and 7 mL to the cathode and anode respectively. Constant current electrolysis was performed at −4 mA until the passage of 3.5 F/mol or until the cell potential reach −10 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 70:30 gradient) to afford tert-butyl (2-(2-(trifluoromethyl)pyridin-4-yl)propyl)carbamate as colorless wax in 72% isolated yield (219 mg, 0.72 mmol).

¹H NMR (¹H NMR (500 MHz, CDCl₃) δ 8.65 (d, J=5.0 Hz, 1H), 7.52 (s, 1H), 7.34 (d, J=5.0 Hz, 1H), 4.52 (s, 1H), 3.38 (dt, J=13.1, 6.3 Hz, 1H), 3.26 (ddd, J=14.0, 8.0, 6.2 Hz, 1H), 3.08 (q, J=7.1 Hz, 1H), 1.40 (s, 9H), 1.31 (d, J=6.9 Hz, 3H).

¹³C NMR (126 MHz, CDCl₃) δ 155.89, 155.58, 150.28, 148.66 (q, J=33.8 Hz), 125.53, 121.74 (d, J=274.3 Hz), 119.73 (d, J=2.1 Hz), 79.86, 46.78, 40.02, 28.42, 18.22.

¹⁹F NMR (377 MHz MHz, CDCl₃) δ −67.9

HRMS (ESI-MS) calcd for C₁₄H₂₀F₃N₂O₂⁺ [M+H]⁺ 305.1471—found—305.1466.

### Lab Scale Flow Procedure and Product Characterization

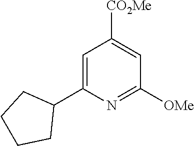 [SMILES: COC(=O)c1cc(OC)nc(C2CCCC2)c1]

### methyl 2-cyclopentyl-6-methoxyisonicotinate

Prepared via general procedure B from methyl 2-chloro-6-methoxyisonicotinate (1.01 g, 5.0 mmol, 1.0 equiv.) and bromocyclopentane (1.12 g, 760 mL, 7.5 mmol, 7.5 equiv.), with NiBr₂·3H₂O (136.5 mg, 0.5 mmol, 10 mol %), dtbbpy (88.5 mg, 0.33 mmol, 6.6 mol %), and ttbtpy (88.0 mg, 0.22 mmol, 4.4 mol %) as catalyst in the cathodic chamber, with 12 mL NMP (0.4 M) as solvent, with LiBr (208 mg, 2.4 mmol) as supporting electrolyte. To the 3-neck flask used as the anodic reservoir was added Na-AQS (78 mg, 0.25 mmol, 5 mol %), and Li₂CO₃ (554 mg, 7.5 mmol, 1.5 equiv.), with 60 mL NMP as solvent, with LiBr (1.04 g, 12 mmol) as supporting electrolyte. The catalytic packed bed reactor contained 10 mg 5% b/w Pd/C. The flow rate of the anolyte through the catalytic hydrogenation reactor was 4 mL min⁻², the flow rate of the catholyte and anolyte through the electrosyn Micro flow cell was set to 20 mL min⁻². Constant current electrolysis was performed at −4 mA·cm⁻² (20 mA with 5 cm² electrode) until the passage of 3.5 F/mol or until the cell potential reach −8 V. Upon completion of the reaction the catholyte was collected and concentrated to dryness. The resultant residue was dissolved in EtOAc and passed through a small plug of silica to remove metal salts and concentrated to dryness. The resultant residue was purified by silica gel chromatography using pentane EtOAc (100:0 to 80:20 gradient) to afford methyl 2-cyclopentyl-6-methoxyisonicotinate as colorless oil in 82% isolated yield (0.97 g, 4.1 mmol).

¹H NMR (500 MHz, CDCl₃) δ 7.27 (d, J=1.2 Hz, 1H), 7.08 (d, J=1.2 Hz, 1H), 3.94 (s, 3H), 3.91 (s, 3H), 3.18-3.10 (m, 1H), 2.09-1.97 (m, 2H), 1.89-1.75 (m, 4H), 1.75-1.61 (m, 2H).

¹³C NMR (126 MHz, CDCl₃) δ 166.22, 165.12, 164.40, 140.29, 113.48, 107.67, 53.69, 52.60, 47.60, 33.44, 25.99.

### Spectroscopic Data Matches Previous Literature Reports.

Schmidt, G.; Bolli, M. H.; Lescop, C.; Abele, S. Org. Process. Res. Dev. 2016, 20, 1637-1646.

### REFERENCES

Salazar, C. A.; Thompson, B. J.; Knapp, S. M. M.; Myers, S. R.; Stahl, S. S. Multichannel Gas-Uptake/Evolution Reactor for Monitoring Liquid-Phase Chemical Reactions. Rev. Sci. Instrum. 2021, 92, 044103.

While a number of embodiments of the present invention have been described above, the present invention is not limited to the disclosed examples.

We claim:

1. An electrosynthetic cell for use in a reductive electrosynthesis of one or more desired chemical products from one or more chemical reactants, the electrosynthetic cell comprising a hydrogen anode half-cell and a cathode half-cell,
wherein the hydrogen anode half-cell comprises:
hydrogen (H₂);
a first liquid phase solution that is in contact with an anode and a heterogeneous redox catalyst capable of catalyzing the oxidation of H₂ to H⁺, wherein the heterogeneous redox catalyst is not affixed to the anode; and
a redox mediator, wherein the redox mediator is capable of transferring or accepting electrons and/or protons while undergoing reduction or oxidation; and
wherein the cathode half-cell comprises:
a second liquid phase solution, the second liquid phase solution comprising the one or more chemical reactants, that is in contact with a cathode and a reductive synthesis catalyst capable of catalyzing the reductive synthesis of the one or more desired chemical products from the one or more chemical reactants.

2. The electrosynthetic cell of claim 1, wherein the one or more chemical reactants comprise a first chemical reactant selected from an aryl halide, a heteroaryl halide, an alkenyl halide, or any combination thereof and a second chemical reactant selected from an alkyl halide, a cycloalkyl halide, a heterocycloalkyl halide, or any combination thereof.

3. The electrosynthetic cell of claim 2, wherein the molar ratio of the first chemical reactant to the second chemical reactant is from 1:1 to 1:2.

4. The electrosynthetic cell of claim 2, wherein the alkyl halide, the cycloalkyl halide, or the heterocycloalkyl halide is optionally substituted with one or more substituents selected from the group consisting of alkyl, haloalkyl, halo, CN, cycloalkyl optionally substituted with one or more halo, —O-cycloalkyl, heterocycloalkyl, —O-heterocycloalkyl, aryl, —O-aryl, heteroaryl, —O— heteroaryl, alkoxy, haloalkoxy, hydroxy, —C(O)OR¹, —OC(O)R¹, —C(O)R₁, —NR¹R², —C(O)NR¹R² and —NR₁C(O)R²; and
wherein R¹ and R² are independently selected from the group consisting of hydrogen, alkyl, —C(O)—O-alkyl, cycloalkyl, heterocycloalkyl, aryl and heteroaryl.

5. The electrosynthetic cell of claim 2, wherein the aryl halide, the heteroaryl halide, or the alkenyl halide is optionally substituted with one or more substituents selected from the group consisting of alkyl, haloalkyl, halo, CN, —B(O₂C₂(CH₃)₄), cycloalkyl, —O-cycloalkyl, heterocycloalkyl, —O-heterocycloalkyl, aryl, —O-aryl, heteroaryl, —O-heteroaryl optionally substituted with NR³R⁴, alkoxy, haloalkoxy, hydroxy, —C(O)OR³, —OC(O)R³, —C(O)R₁, —NR³R⁴, —C(O)NR³R⁴, and —NR³C(O)R⁴; and
wherein R³ and R⁴ are independently selected from the group consisting of hydrogen, alkyl, —C(O)—O-alkyl, cycloalkyl, heterocycloalkyl, aryl and heteroaryl.

6. The electrosynthetic cell of claim 1, wherein the redox mediator is dissolved within the first liquid phase solution and is capable of moving between the anode and the redox catalyst and wherein the electrosynthetic cell is configured to reduce an oxidized form of the redox mediator at the redox catalyst and oxidize a reduced form of the redox mediator at the anode.

7. The electrosynthetic cell of claim 6, wherein the reduced form of the redox mediator is selected from the group consisting of 1,4-dihydroxybenzene, 9,10-dihydroxyanthracene, and combinations thereof, and
wherein the 1,4-dihydroxybenzene or 9,10-dihydroxyanthracene is optionally substituted with one or more substituents selected from the group consisting of alkyl and thioether substituted with sulfonate.

8. The electrosynthetic cell of claim 2, wherein the redox mediator is at least 0.1 mol % based on the molar amount of the first chemical reactant.

9. The electrosynthetic cell of claim 1, wherein the redox mediator has a concentration of at least 5 mM in the first liquid phase solution.

10. The electrosynthetic cell of claim 1, wherein the redox catalyst comprises one or more metals selected from the group consisting of Pt, Pd, and combinations thereof.

11. The electrosynthetic cell of claim 1, wherein the redox catalyst is at least 1 mol %, based on the molar amount of the redox mediator.

12. The electrosynthetic cell of claim 1, wherein the first liquid phase solution of the anode half-cell or the second liquid phase solution of the cathode half-cell is selected from the group consisting of N-methylpyrrolidone (NMP), N,N-dimethylformamide (DMF), N,N-dimethylacetamide (DMA), N,N′-dimethylpropyleneurea (DMPU), propylene carbonate, tetrahydrofuran (THF), methanol (MeOH), acetonitrile (MeCN), 1,3-dimethyl-2-imidazolidinone (DMI), and combinations thereof.

13. The electrosynthetic cell of claim 1, wherein the first liquid phase solution of the anode half-cell or the second liquid phase solution of the cathode half-cell further comprises a supporting electrolyte selected from the group consisting of tetrabutylammonium hexafluorophosphate (NBu₄PF₆), lithium bromide (LiBr), potassium hexafluorophosphate (KPF₆), cesium fluoride (CsF), lithium chloride (LiCl), tetrabutylammonium tetrafluoroborate (NBu₄BF₄), potassium chloride (KCl), and combinations thereof.

14. The electrosynthetic cell of claim 1, wherein the reductive synthesis catalyst comprises Ni and one or more ligands selected from the group consisting of 4,4′-di-tert-butyl-2,2-dipyridyl (dtbbpy), 4,4,′,4″-tri-tert-butyl-2,2′:6′,2″-terpyridine (ttbtpy), 2,9-dimethylphenanthroline, bathocuperoine, 1,2-bis(diphenylphosphino)ethane, and combinations thereof.

15. The electrosynthetic cell of claim 14, wherein the one or more ligands comprise dtbbpy and ttbtpy, and the ratio of dtbbpy to ttbtpy is from 1:2 to 5:1.

16. The electrosynthetic cell of claim 2, wherein the reductive synthesis catalyst is from 0.1 mol % to 30 mol %, based on the molar amount of the first chemical reactant.

17. The electrosynthetic cell of claim 2, wherein the hydrogen anode half-cell further comprises a base selected from the group consisting of alkali carbonate, alkali hydroxide, alkali phosphate, alkali zeolite, strong base anion (SBA) exchange resin, and combinations thereof.

18. The electrosynthetic cell of claim 17, wherein a molar ratio of the base to the first chemical reactant is from 1:1 to 1:4.

19. The electrosynthetic cell of claim 1, wherein the cathode half-cell further comprises one or more desired chemical products and the one or more desired chemical products comprise a reductive C(sp²)-C(sp³) coupled product.

20. The electrosynthetic cell of claim 1, further comprising a device capable of applying an external electromotive force to the anode and the cathode to remove electrons from the anode and to add electrons to the cathode.

21. The electrosynthetic cell of claim 20, wherein the external electromotive force has a current density of from 0.01 mA·cm⁻² to 20 mA·cm⁻².

22. The electrosynthetic cell of claim 1, further comprising an anion exchange membrane or a cation exchange membrane separating the hydrogen anode half-cell and the cathode half-cell.

23. A method of using the electrosynthetic cell of claim 1 to produce the one or more desired chemical products from the one or more chemical reactants, the method comprising applying an external electromotive force to remove electrons from the anode and to add electrons to the cathode.

24. The method of claim 23, wherein applying an external electromotive force to remove electrons from the anode and to add electrons to the cathode results in oxidation of H₂ to H⁺ at the redox catalyst, reversable reduction and oxidation of the redox mediator, and reduction of the one or more chemical reactants to produce the one or more desired chemical products.

25. The method of claim 23, wherein the external electromotive force has a current density of from 0.01 mA·cm⁻² to 20 mA·cm⁻².
